(19) United States
(12) Patent Application Publication
(10) Pub. No.: US 2026/0074115 A1
(43) Pub. Date: Mar. 12, 2026

(54) MULTILAYER CERAMIC CAPACITOR

(71) Applicant: Murata Manufacturing Co., Ltd., Nagaokakyo-shi (JP)

(72) Inventors: Yasuyuki SHIMADA, Nagaokakyo-shi (JP); Tatsunori YASUDA, Nagaokakyo-shi (JP)

(21) Appl. No.: 19/389,193

(22) Filed: Nov. 14, 2025

Related U.S. Application Data
(63) Continuation of application No. PCT/JP2024/014773, filed on Apr. 12, 2024.

(30) Foreign Application Priority Data
Jun. 21, 2023 (JP) 2023-101746

(51) Int. Cl. H01G 4/12; H01G 4/012; H01G 4/232; H01G 4/30

(52) U.S. Cl. CPC H01G 4/1236; H01G 4/012; H01G 4/1227; H01G 4/2325; H01G 4/30

(57) ABSTRACT

A multilayer ceramic capacitor includes interlayer regions sandwiched between two layers, among main dielectric layers and outer layers that are adjacent in a lamination direction, and auxiliary dielectric layers in the interlayer regions. The interlayer regions include a first region positioned between one of end surfaces and an internal electrode, and a second region overlapping with the internal electrode in the interlayer region. The auxiliary dielectric layer is located in each of the first region and the second region. A main component of a dielectric ceramic is the same for the auxiliary dielectric layers in the first and second regions. A main component of a dielectric ceramic in the auxiliary dielectric layer in the first region differs from that in the main dielectric layer.

### CROSS REFERENCE TO RELATED APPLICATIONS

This application claims the benefit of priority to Japanese Patent Application No. 2023-101746, filed on Jun. 21, 2023, and is a Continuation Application of PCT Application No. PCT/JP2024/014773, filed on Apr. 12, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Multilayer ceramic capacitors in which a plurality of dielectric layers and a plurality of internal electrodes are laminated are known.

The multilayer ceramic capacitors are each manufactured by laminating dielectric sheets on which internal electrodes are printed. The internal electrodes are each printed only on a portion of a corresponding one of the dielectric sheets. Therefore, a step difference due to such an internal electrode is formed on the dielectric sheet. When the dielectric sheets are laminated, the multilayer ceramic capacitor may be deformed due to the accumulation of the step differences.

Therefore, a paste for step difference absorption is printed on a portion of each of the dielectric sheets on which the internal electrode is not printed, thus reducing the step differences (see, for example, Japanese Unexamined Patent Application, Publication No. 2005-079284).

However, the step of printing the paste for step difference absorption requires time and effort because accuracy is required in the positioning of the paste.

### SUMMARY OF THE INVENTION

Example embodiments of the present invention provide multilayer ceramic capacitors that are each able to easily absorb a step difference.

A multilayer ceramic capacitor according to an example embodiment of the present invention includes a multilayer body including an inner layer portion including a plurality of main dielectric layers and a plurality of internal electrodes alternately laminated, a first main surface and a second main surface opposed to each other in a lamination direction, a first end surface and a second end surface opposed to each other in a length direction orthogonal or substantially orthogonal to the lamination direction, a first lateral surface and a second lateral surface opposed to each other in a width direction orthogonal or substantially orthogonal to both of the lamination direction and the length direction, and a pair of outer layer portions sandwiching the inner layer portion in the lamination direction, a first external electrode on the first end surface, and a second external electrode on the second end surface. The multilayer body includes a plurality of interlayer regions each sandwiched between a corresponding one of the plurality of main dielectric layers and a corresponding one of the outer layer portions adjacent to each other in the lamination direction, and a plurality of auxiliary dielectric layers each provided in a corresponding one of the interlayer regions. Each of the plurality of interlayer regions includes a first region located between one of the first end surface or the second end surface, and a corresponding one of the plurality of internal electrodes, and a second region overlapping a corresponding one of the plurality of internal electrodes provided in a corresponding one of the plurality of interlayer regions when viewed in the lamination direction. Each of the plurality of auxiliary dielectric layers is provided in both of the first region and the second region. Each of the plurality of auxiliary dielectric layers provided in the first region and each of the plurality of auxiliary dielectric layers provided in the second region include a same main component of a dielectric ceramic. Each of the plurality of auxiliary dielectric layers provided in the first region and each of the plurality of main dielectric layers include different main components of a dielectric ceramic.

According to example embodiments of the present invention, multilayer ceramic capacitors that are each able to easily absorb a step difference are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to a first example embodiment of the present invention.

FIG. 2 is a cross-sectional view of the multilayer ceramic capacitor 1 according to the first example embodiment of the present invention taken along the line II-II in FIG. 1.

FIG. 3 is a cross-sectional view of the multilayer ceramic capacitor 1 according to the first example embodiment of the present invention taken along the line III-III in FIG. 1.

FIG. 4 is a cross-sectional view along a first internal electrode 15A of a multilayer body 2 according to the first example embodiment of the present invention.

FIG. 5 is a schematic perspective view of a multilayer ceramic capacitor 100 according to a second example embodiment of the present invention.

FIG. 6 is a cross-sectional view of the multilayer ceramic capacitor 100 according to the second example embodiment of the present invention taken along the line VI-VI in FIG. 5.

FIG. 7 is a cross-sectional view of the multilayer ceramic capacitor 100 according to the second example embodiment of the present invention taken along the line VII-VII in FIG. 5.

FIG. 8 is a cross-sectional view along an extension internal electrode 151 of the multilayer body 102 according to the second example embodiment of the present invention.

FIG. 9 is a cross-sectional view along a first floating internal electrode 152A of the multilayer body 102 according to the second example embodiment of the present invention.

FIG. 10 is a cross-sectional view according to a modified example of the second example embodiment of the present invention, and corresponds to FIG. 6 of the multilayer ceramic capacitor 100.

FIG. 11 is a cross-sectional view along the extension internal electrode 151 and a second floating internal electrode 152B of the multilayer body 102 according to the modified example of the second example embodiment of the present invention.

FIG. 12 is a cross-sectional view along the first floating internal electrode 152A and a third floating internal electrode 152C of the multilayer body 102 according to the modified example of the second example embodiment of the present invention.

FIG. 13 is a schematic perspective view of a multilayer ceramic capacitor 200 according to a third example embodiment of the present invention.

FIG. 14 is a cross-sectional view of the multilayer ceramic capacitor 200 according to the third example embodiment of the present invention taken along the line XIV-XIV in FIG. 13.

FIG. 15 is a cross-sectional view of the multilayer ceramic capacitor 200 according to the third example embodiment of the present invention taken along the line XV-XV in FIG. 13.

FIG. 16 is a cross-sectional view along an end surface internal electrode 215A of the multilayer body 202 according to the third example embodiment of the present invention.

FIG. 17 is a cross-sectional view of the multilayer body 202 according to the third example embodiment of the present invention taken along a lateral surface internal electrode 215B.

FIG. 18 is a schematic perspective view of a multilayer ceramic capacitor 300 according to a fourth example embodiment of the present invention.

FIG. 19 is a cross-sectional view of the multilayer ceramic capacitor 300 according to the fourth example embodiment of the present invention taken along the line XIX-XIX in FIG. 18.

FIG. 20 is a cross-sectional view of the multilayer ceramic capacitor 300 according to the fourth example embodiment of the present invention taken along the line XX-XX in FIG. 18.

FIG. 21 is a cross-sectional view of the multilayer ceramic capacitor 300 according to the fourth example embodiment of the present invention taken along a first end surface-lateral surface internal electrode 315A.

FIG. 22 is a cross-sectional view of the multilayer ceramic capacitor 300 according to the fourth example embodiment of the present invention taken along a second end surface-lateral surface internal electrode 315B.

### DETAILED DESCRIPTION OF THE EXAMPLE EMBODIMENTS

Example embodiments of the present invention will be described in detail below with reference to the drawings.

### First Example Embodiment

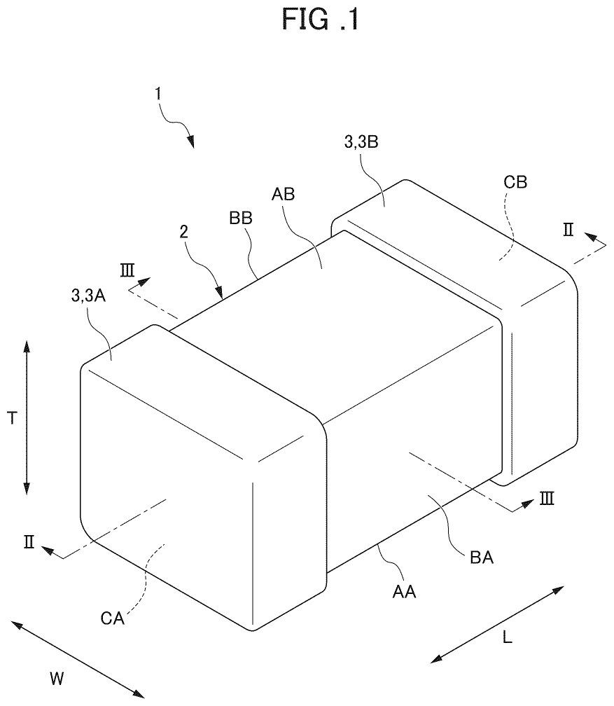

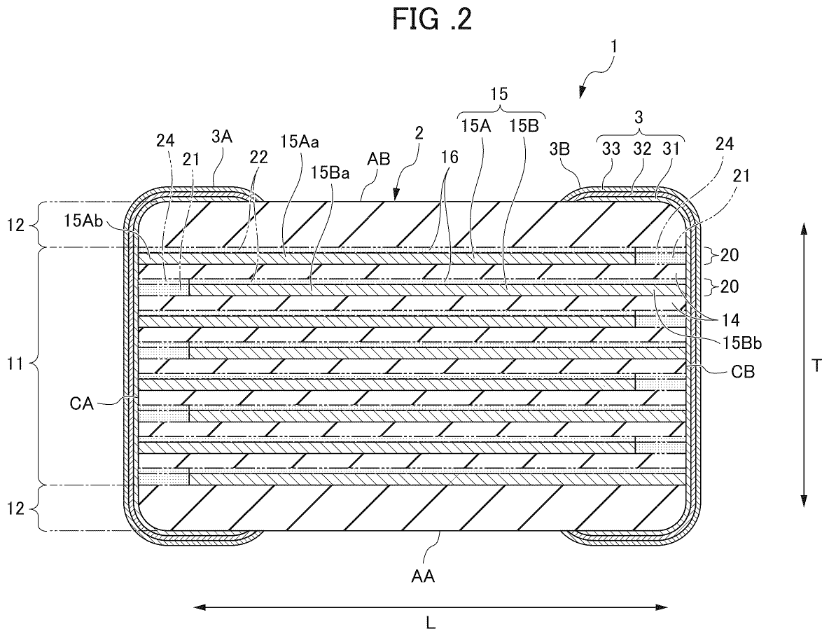

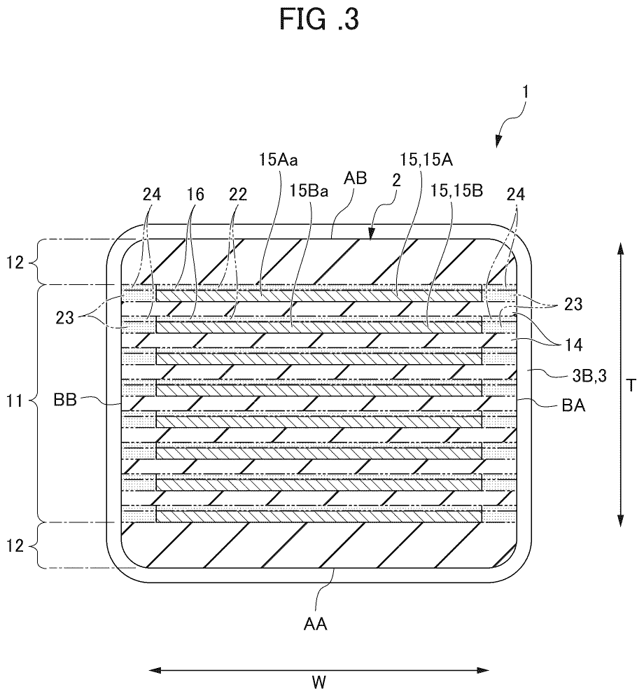

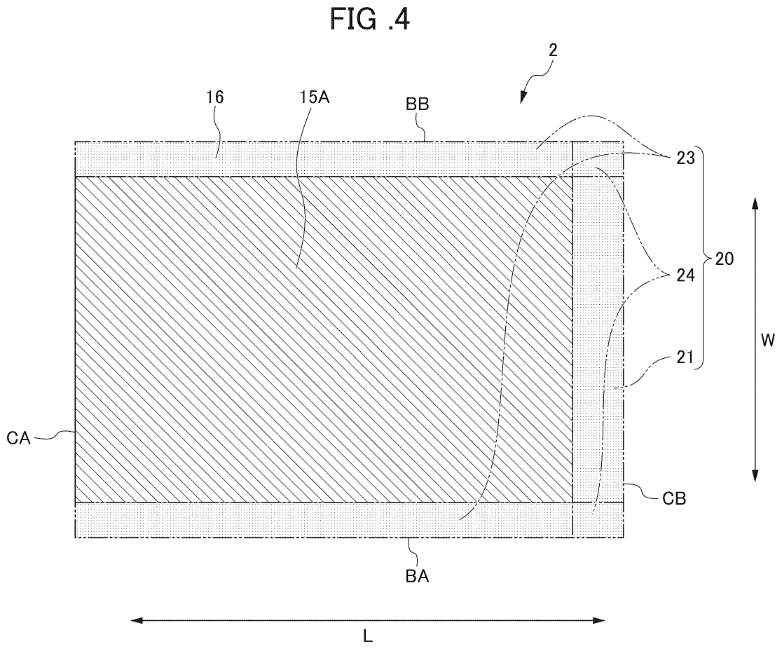

Hereinafter, a multilayer ceramic capacitor 1 according to a first example embodiment of the present invention will be described with reference to FIGS. 1 to 4. FIG. 1 is a schematic perspective view of a multilayer ceramic capacitor 1 according to a first example embodiment. FIG. 2 is a cross-sectional view of the multilayer ceramic capacitor 1 according to the first example embodiment taken along the line II-II in FIG. 1. FIG. 3 is a cross-sectional view of the multilayer ceramic capacitor 1 according to the first example embodiment taken along the line III-III in FIG. 1. FIG. 4 is a cross-sectional view along a first internal electrode 15A of a multilayer body 2 according to the first example embodiment.

As shown in FIG. 1, the multilayer ceramic capacitor 1 is, for example, a multilayer ceramic capacitor 1 including a two-terminal configuration including a pair of external electrodes 3 each provided on a corresponding one of both end surfaces C of the multilayer body 2 in the length direction L. The multilayer body 2 includes an inner layer portion 11 in which main dielectric layers 14 and internal electrodes 15 are laminated, and outer layer portions 12.

In the present example embodiment, as terms indicating the orientation of the multilayer ceramic capacitor 1, a direction in which the main dielectric layers 14 and the internal electrodes 15 are laminated in the multilayer ceramic capacitor 1 is defined as a lamination direction T. A direction orthogonal or substantially orthogonal to the lamination direction T and in which the pair of external electrodes 3 are provided is defined as a length direction L. A direction orthogonal or substantially orthogonal to both of the length direction L and the lamination direction T is defined as a width direction W.

In the following description, among the six outer surfaces of the multilayer body 2, a pair of outer surfaces provided on both sides in the lamination direction T are defined as main surfaces A, a pair of outer surfaces extending in the lamination direction T and provided on both sides in the width direction W are defined as lateral surfaces B, and a pair of outer surfaces extending in the lamination direction T and provided on both sides in the length direction L are defined as end surfaces C. One of the main surfaces A is referred to as a first main surface AA, and the other is referred to as a second main surface AB. One of the lateral surfaces B is referred to as a first lateral surface BA, and the other is referred to as a second lateral surface BB. One of the end surfaces C is referred to as a first end surface CA, and the other is referred to as a second end surface CB.

Among the pair of external electrodes 3, the external electrode 3 provided on the first end surface CA is referred to as a “first external electrode 3A”, and the external electrode 3 provided on the second end surface CB is referred to as a “second external electrode 3B”. When it is not particularly necessary to distinguish between them, the first external electrode 3A and the second external electrode 3B may be collectively referred to as “each external electrode 3”.

The multilayer body 2 includes an inner layer portion 11 and a pair of outer layer portions 12 provided on both sides of the inner layer portion 11 in the lamination direction T. It is preferable that the multilayer body 2 has rounded corner portions and ridge portions. Each of the corner portions is a portion where three surfaces of the multilayer body intersect with each other, and each of the ridge portions is a portion where two surfaces of the multilayer body intersect with each other.

As shown in FIGS. 2 and 3, the inner layer portion 11 includes a stack in which the plurality of main dielectric layers 14 and the plurality of internal electrodes 15 are laminated along the lamination direction T.

The main dielectric layers 14 are each made of a dielectric ceramic. The main component of the dielectric ceramic of each of the main dielectric layers 14 is, for example, a perovskite compound including Ba and Ti, preferably BaTiO₃. With such a configuration, since the permittivity of each of the main dielectric layers 14 can be improved, it is possible to improve the capacitance of the multilayer ceramic capacitor 1. The dielectric ceramic of each of the main dielectric layers 14 may include, for example, at least one additive selected from a Mn compound, a Fe compound, a Cr compound, a Co compound, or a Ni compound, in addition to the main component. The “main component of the dielectric ceramic” indicates a component having the largest content in the dielectric ceramic.

The internal electrodes 15 are each made of a metal material such as, for example, Ni, Cu, Ag, Pd, an Ag-Pd alloy, or Au. As will be described later in detail, for example, Sn is preferably added to each of the internal electrodes 15.

The internal electrodes 15 include first internal electrodes 15A extending toward the first end surface CA and second internal electrodes 15B extending toward the second end surface CB. The first internal electrodes 15A and the second internal electrodes 15B are alternately provided in the lamination direction T.

Each of the first internal electrodes 15A includes a first counter portion 15Aa located in a middle portion between both end surfaces C, and a first extension portion 15Ab extending from the first counter portion 15Aa toward the first end surface CA. The first extension portion 15Ab is exposed at the first end surface CA. Each of the first internal electrodes 15A is separated from the second end surface CB and both lateral surfaces B.

Each of the second internal electrodes 15B includes a second counter portion 15Ba located in a middle portion between both end surfaces C, and a second extension portion 15Bb extending from the second counter portion 15Ba toward the second end surface CB. The second extension portion 15Bb is exposed at the second end surface CB. Each of the second internal electrodes 15B is separated from the first end surface CA and both lateral surfaces B. In addition, the first counter portion 15Aa and the second counter portion 15Ba may be collectively referred to as a “counter portion 15a” when it is not particularly necessary to distinguish between them. The first extension portion 15Ab and the second extension portion 15Bb may be collectively referred to as an “extension portion 15b” when it is not particularly necessary to distinguish between them.

Each of the outer layer portions 12 is an aggregate of dielectric layers having a constant thickness and provided on a side of the inner layer portion 11 adjacent to the main surface A. Each of the outer layer portions 12 is made of, for example, the same material as the main dielectric layers 14, and includes a plurality of dielectric layers. However, the present invention is not limited thereto, and the outer layer portions 12 may be made of a material different from that of the main dielectric layers 14. For example, the outer layer portions 12 may be made of a material having a permittivity lower than that of the main dielectric layers 14. The outer layer portions 12 may be made of a component excellent in moisture resistance, weather resistance, and strength. Each of the outer layer portions 12 may include a single dielectric layer. Each of the outer layer portions 12 may include, for example, a diamond-like carbon (DLC) layer or a SiO₂ layer.

Each of the external electrodes 3 includes, for example, a base electrode layer 31, a Ni (nickel) plated layer 32 provided on the base electrode layer 31, and a Sn (tin) plated layer 33 provided on the Ni plated layer 32. Each of the external electrodes 3 covers a corresponding one end surface C and each end portion in the length direction L of the main surface A and the lateral surface B. The first extension portions 15Ab are connected to the first external electrode 3A. The second extension portions 15Bb are connected to the second external electrode 3B.

Here, the multilayer body 2 includes interlayer regions 20, and each of the interlayer regions 20 is sandwiched by dielectric layers among the main dielectric layers 14 and the outer layer portions 12 adjacent to each other in the lamination direction T.

The internal electrodes 15 are respectively provided in the interlayer regions 20. Each of the interlayer regions 20 includes a first region 21 provided between one of the end surfaces C and a corresponding one of the internal electrodes 15, a second region 22 overlapping the internal electrodes 15 each provided in the interlayer region 20 when viewed in the lamination direction T, a third region 23 provided between one of the lateral surfaces B and a corresponding one of the internal electrodes 15, and a remaining region 24 not included in any of the first region 21, the second region 22, and the third region 23. In addition, each of the internal electrodes 15 is in contact with a corresponding one of the main dielectric layers 14 adjacent to the first main surface AA. Therefore, the second region 22 is located between the surface of a corresponding one of the internal electrodes 15 adjacent to the second main surface AB and a corresponding one of the main dielectric layers 14.

In each of the interlayer regions 20 in which the first internal electrode 15A is provided, the remaining region 24 includes a region provided adjacent to the second end surface CB and the first lateral surface BA relative to the first internal electrode 15A provided in the interlayer region 20, a region provided adjacent to the second end surface CB and the second lateral surface BB relative to the first internal electrode 15A, a region overlapping the first region 21 of the interlayer region 20 as viewed in the lamination direction T, and a region overlapping the third region 23 of the interlayer region 20 as viewed in the lamination direction T. In each of the interlayer regions 20 in which the second internal electrode 15B is provided, the remaining region 24 includes a region provided adjacent to the first end surface CA and the first lateral surface BA relative to the second internal electrode 15B provided in the interlayer region 20, a region provided adjacent to the first end surface CA and the second lateral surface BB relative to the second internal electrode 15B, a region overlapping the first region 21 of the interlayer region 20 as viewed in the lamination direction T, and a region overlapping the third region 23 of the interlayer region 20 as viewed in the lamination direction T.

The multilayer body 2 includes auxiliary dielectric layers 16 provided in each of the interlayer regions 20.

The auxiliary dielectric layer 16 covers the entire or substantially the entire surface of a corresponding one of the main dielectric layers 14 adjacent to the second main surface AB on which the internal electrodes 15 are provided, directly or indirectly. In this case, in the interlayer region 20, the auxiliary dielectric layer 16 is provided in each of the first region 21, the second region 22, the third region 23, and the remaining region 24. In this case, for example, as compared with the case where the auxiliary dielectric layer 16 is provided only in the first region 21, it is possible to easily provide the auxiliary dielectric layer. It can also be said that the first region 21, the second region 22, the third region 23, and the remaining region 24 are provided by providing the auxiliary dielectric layer 16. The first region 21 is an example of a first region.

In the interlayer region 20, the auxiliary dielectric layer 16 may be provided adjacent to the first region 21 in the lamination direction T. In this case, the auxiliary dielectric layer 16 provided in the region adjacent to the first region 21 in the lamination direction T provides the remaining region 24 in a region overlapping the first region 21 when viewed in the lamination direction T.

In addition, the auxiliary dielectric layer 16 may be provided at least between one of the end surfaces C and a corresponding one of the internal electrodes 15 and may overlap a corresponding one of the internal electrodes 15 provided in the interlayer region 20 when viewed in the lamination direction T, and is not limited to the above-described configurations.

Similarly to the main dielectric layers 14, the auxiliary dielectric layers 16 are made of dielectric ceramic. However, the main component of the dielectric ceramic of the auxiliary dielectric layer 16 and the main component of the dielectric ceramic of the main dielectric layer 14 are different from each other. The dielectric ceramic of each of the auxiliary dielectric layers 16 includes, for example, Ba, Ti, Ca, Zr, or Sr. The main component of the dielectric ceramic of each of the auxiliary dielectric layers 16 is, for example, any one of CaTiO₃, CaZrO₃, or SrTiO₃, and preferably any one of CaTiO₃ or CaZrO₃. In this case, it is possible to reduce or prevent the occurrence of dielectric breakdown suitably by the auxiliary dielectric layers 16. Further, the main components of the dielectric ceramic are the same among the auxiliary dielectric layer 16 provided in the first region 21, the auxiliary dielectric layer 16 provided in the second region 22, the auxiliary dielectric layer 16 provided in the third region 23, and the auxiliary dielectric layer 16 provided in the remaining region 24.

The auxiliary dielectric layer 16 is provided in the first region 21. In this case, the auxiliary dielectric layer 16 is provided between the end portion of the internal electrode 15 opposite to the extension portion 15b and the external electrode 3. With such a configuration, it is possible to reduce or prevent the generation of a step difference due to the internal electrode 15. When the main component of the dielectric ceramic of the auxiliary dielectric layer 16 provided in the first region 21 is, for example, any one of CaTiO₃, CaZrO₃, or SrTiO₃, it is possible to reduce or prevent the occurrence of dielectric breakdown between the internal electrode 15 and the external electrode 3 suitably.

The auxiliary dielectric layer 16 is provided in the second region 22. In this case, the main dielectric layer 14 and the auxiliary dielectric layer 16 are provided between the first internal electrodes 15A and the second internal electrodes 15B which are adjacent to each other in the lamination direction T. With such a configuration, it is possible to provide the auxiliary dielectric layer 16 easily as compared with the case where the auxiliary dielectric layer 16 is provided only in the first region 21. Further, when the main component of the dielectric ceramic of the auxiliary dielectric layer 16 provided in the second region 22 is, for example, any one of CaTiO₃, CaZrO₃, or SrTiO₃, it is possible to reduce or prevent the occurrence of dielectric breakdown between the internal electrodes 15 adjacent to each other in the lamination direction T suitably.

The main component of the dielectric ceramic of the main dielectric layer 14 is preferably a component having a higher permittivity than the main component of the dielectric ceramic of the auxiliary dielectric layer 16 provided in the second region 22. For example, it is preferable that the main component of the dielectric ceramic of the auxiliary dielectric layer 16 provided in the second region 22 is one of CaTiO₃ or CaZrO₃, and the main component of the dielectric ceramic of the main dielectric layer 14 is BaTiO₃. As described above, by providing a component capable of suitably reducing or preventing the dielectric breakdown for the main component of the dielectric ceramic of the auxiliary dielectric layer 16, and providing a component having a relatively high permittivity for the main component of the dielectric ceramic of the main dielectric layer 14, it is possible to improve the capacitance of the multilayer ceramic capacitor 1 while reducing or preventing the occurrence of dielectric breakdown.

The dimension in the lamination direction T of each of the auxiliary dielectric layers 16 provided in the second region 22 is, for example, preferably about 0.1μm or more. With such a configuration, it is possible to more reliably reduce or prevent the dielectric breakdown between the internal electrodes 15 adjacent to each other in the lamination direction T by the auxiliary dielectric layers 16 provided in the second region 22. The dimension in the lamination direction T of each of the auxiliary dielectric layers 16 provided in the second region 22 is, for example, preferably about 5.0μm or less. With such a configuration, it is possible to reduce or prevent dielectric breakdown while reducing or preventing an excessive increase in the element thickness of the dielectric ceramic layers between the internal electrodes 15 adjacent to each other in the lamination direction T.

The dimension in the lamination direction T of the main dielectric layer 14 is preferably greater than the dimension in the lamination direction T of the auxiliary dielectric layer 16 provided in the second region 22. With such a configuration, since it is possible to provide a greater amount of materials having a relatively high permittivity between the first internal electrode 15A and the second internal electrode 15B, it is possible to improve the capacitance of the multilayer ceramic capacitor 1, and it is possible to improve the dielectric breakdown voltage. In addition, since the dimension in the lamination direction T of the auxiliary dielectric layer 16 provided in the second region 22 is set to be relatively small, it is possible to obtain these advantageous effects while reducing or preventing an excessive increase in the element thickness of the dielectric ceramic layer between the internal electrodes 15 adjacent to each other in the lamination direction T.

The auxiliary dielectric layer 16 is provided in the third region 23. In this case, the auxiliary dielectric layer 16 is provided between the internal electrode 15 and each lateral surface B. With such a configuration, it is possible to reduce or prevent the generation of a step difference due to the internal electrode 15. As compared with the case where the auxiliary dielectric layer 16 is provided only in the first region 21, it is possible to easily provide the auxiliary dielectric layer 16. The main component of the dielectric ceramic of the auxiliary dielectric layer 16 provided in the third region 23 and the main component of the dielectric ceramic of the auxiliary dielectric layer 16 provided in the first region 21 are the same as each other. With such a configuration, it is possible to reduce or prevent the occurrence of dielectric breakdown at each end portion of the internal electrode 15 in the width direction W.

The auxiliary dielectric layer 16 is provided in the remaining region 24. With such a configuration, it is possible to more suitably reduce or prevent deformation of the multilayer body 2.

When dielectric layers among the outer layer portions 12 and the main dielectric layers 14 adjacent to each other in the lamination direction T are in contact with each other, the interlayer region 20 is not provided in the contact portion. As described above, the auxiliary dielectric layer 16 is provided at least in a region between one of the end surfaces C and the internal electrode 15 and a region overlapping the internal electrode 15 provided in the interlayer region 20 when viewed in the lamination direction T. With such a configuration, the interlayer region 20 includes at least a first region 21 and a second region 22. The third region 23 and the remaining region 24 are not required to be provided.

In addition, the multilayer body 2 may include side gap portions (described later in detail) respectively provided on the lateral surfaces B. In this case, the third region is not provided in portions where the side gap portions are provided in the multilayer body 2.

Further, for example, the internal electrodes 15 preferably include Sn. In this case, it is possible to relax the electric field concentration at the interface between the internal electrodes 15 and the main dielectric layers 14 or the auxiliary dielectric layers 16, and to improve the high-temperature load reliability.

Methods for measuring the dielectric component include, for example, a method of observing an LT cross section (may be referred to as a “reference cross section”) in the vicinity of the middle in the width direction W of the multilayer body exposed by polishing. Examples of the measuring instrument include wavelength dispersive X-ray analysis (WDX) or energy dispersive X-ray analysis (EDX), and a scanning electron microscope (SEM) or a transmission electron microscope (TEM). Each value may be an average value of a plurality of measured values at a plurality of locations in the lamination direction T.

Further, the dimensions of the main dielectric layers 14 and the auxiliary dielectric layers 16 in the lamination direction T can be determined by measuring a reference cross section with a micrometer or an optical microscope. Each value may be an average value of a plurality of measured values at a plurality of locations in the length direction L.

Next, a non-limiting example of a method for manufacturing the multilayer ceramic capacitor 1 according to the present example embodiment will be described.

First, a dielectric sheet for a main dielectric layer, an electrically conductive paste for an internal electrode, and a dielectric paste for an auxiliary dielectric layer 16 are prepared. The dielectric sheet for the main dielectric layer is also used as a dielectric sheet for the outer layer portions.

The dielectric sheet for the main dielectric layer is a ceramic green sheet, and is obtained, for example, by forming a ceramic slurry including ceramic powder, a binder, and a solvent into a sheet shape on a carrier film using a die coater, a gravure coater, a microgravure coater, or the like. The ceramic powder includes a dielectric ceramic. The main component of the dielectric ceramic is, for example, BaTiO_{3.}

The dielectric paste for the auxiliary dielectric layer is obtained, for example, by adding a binder resin (for example, an organic binder resin) and a solvent to a ceramic powder, and further mixing and dispersing them. The ceramic powder includes a dielectric ceramic. The main component of the dielectric ceramic is, for example, one of CaTiO₃ or CaZrO₃.

The electrically conductive paste for an internal electrode is obtained by mixing a metal powder defining and functioning as a conductor, an organic solvent, a binder, and a dispersant.

The components of the dielectric sheet, the dielectric paste, and the electrically conductive paste are not limited thereto, and can be appropriately changed. The dielectric sheet, the dielectric paste, and the electrically conductive paste can be provided by a known method, for example. The grain diameter and the ceramic particle size of the dielectric sheet and the dielectric paste can be appropriately changed. The breakdown voltage of the auxiliary dielectric layer 16 can be improved by making the grain diameter and the ceramic particle size of the dielectric paste for the auxiliary dielectric layer smaller than the grain diameter and the ceramic particle size of the dielectric sheet for the main dielectric layer, respectively, and increasing the grain boundaries.

Next, the internal electrodes 15 are provided. The electrically conductive paste for the internal electrodes 15 is printed (applied) on the dielectric sheet for the main dielectric layer 14. The electrically conductive paste is printed in a desired pattern by, for example, screen printing or gravure printing.

Auxiliary dielectric layers 16 are then provided. The dielectric paste for the auxiliary dielectric layer is printed (applied) on the dielectric sheet on which the electrically conductive paste is printed. The dielectric paste is printed in a desired pattern by, for example, screen printing, gravure printing, a die coater, a gravure coater, or a microgravure coater.

Excess of the printed dielectric paste is scraped off by a blade or the like. At this time, the shape of the auxiliary dielectric layer 16 and the dimension in the lamination direction T can be adjusted by changing the separation distance between the blade and the dielectric sheet, the movement speed of the blade, the shape of the blade, and the like. The method for adjusting the shape of the auxiliary dielectric layer 16 and the dimension in the lamination direction T is not limited thereto and, for example, the viscosity of the dielectric paste may be changed, or the type of the binder or the organic solvent included in the dielectric paste may be changed.

Dielectric sheets for the main dielectric layer 14 are then laminated. Then, the dielectric sheets for the outer layer portion are thermocompression-bonded to the upper and lower surfaces thereof. Thus, a mother block is provided. The mother block is divided by being cut in the length direction L and the width direction W. As a result, a plurality of blocks (may be referred to as “multilayer chips”) defining and functioning as the multilayer body 2 are manufactured. The multilayer chip may be rounded at corner portions or ridge portions by barrel polishing, for example.

Next, the multilayer chip is heated at a predetermined firing temperature in a nitrogen atmosphere for a predetermined period of time. Thus, the multilayer body 2 is manufactured.

Next, the base electrode layer 31 is provided on both end surfaces C of the multilayer body 2. The base electrode layer 31 is provided so as to cover not only the end surfaces C on both sides of the multilayer body 2, but also the end portions of the main surfaces A and the lateral surfaces B in the length direction L. The base electrode layer 31 is provided by, for example, applying an electrically conductive paste including an electrically conductive metal and glass to both end surfaces C of the multilayer body 2 and firing the paste. As a method for applying the electrically conductive paste for the base electrode layer, for example, a dipping method can be used. The base electrode layer 31 may be provided by, for example, simultaneously firing a multilayer chip and an electrically conductive paste applied to the multilayer chip.

Next, for example, the Ni plated layer 32 is provided so as to cover the surface of the base electrode layer 31. Next, for example, a Sn plated layer 33 is provided so as to cover the Ni plated layer 32. As a method for providing the Ni plated layer 32 and the Sn plated layer 33, an electrolytic plating method is preferably used. As the plating method, barrel plating can be used, for example.

Through the above steps, the multilayer ceramic capacitor 1 in which the external electrodes 3 are provided on the multilayer body 2 is manufactured.

According to the present example embodiments, it is possible to achieve the following advantageous effects.

An auxiliary dielectric layer is provided in the first region. With such a configuration, since it is possible to reduce or prevent the generation of a step difference due to the internal electrode, it is possible to reduce or prevent the deformation of the multilayer ceramic capacitor.

The auxiliary dielectric layer is provided not only in the first region, but also in the second region. In this case, since the auxiliary dielectric layer can be easily provided as compared with the case where the auxiliary dielectric layer is provided only in the first region, the multilayer ceramic capacitor can be easily manufactured. Therefore, it is possible to provide a multilayer ceramic capacitor capable of easily absorbing a step difference.

The main component of the dielectric ceramic of the auxiliary dielectric layer 16 is, for example, any one of CaTiO₃, CaZrO₃, or SrTiO₃, and preferably any one of CaTiO₃ or CaZrO₃. With such a configuration, it is possible to reduce or prevent the occurrence of dielectric breakdown around the internal electrode 15.

The main component of the dielectric ceramic of the main dielectric layer 14 is, for example, a perovskite compound including Ba and Ti, and preferably BaTiO₃. With such a configuration, since the permittivity of the main dielectric layer 14 can be improved, it is possible to improve the capacitance of the multilayer ceramic capacitor 1.

The auxiliary dielectric layer is also provided in the third region 23, in addition to the first region 21 and the second region 22. In this case, it is possible to provide the auxiliary dielectric layer more easily.

The dimension in the lamination direction T of the auxiliary dielectric layer 16 provided in the second region 22 is, for example, about 0.1 μm or more. This makes it possible to reduce or prevent the occurrence of dielectric breakdown between the internal electrodes 15 adjacent to each other in the lamination direction T.

The dimension in the lamination direction T of the auxiliary dielectric layer 16 provided in the second region 22 is, for example, about 5.0 μm or less. This makes it possible to reduce or prevent dielectric breakdown, while reducing or preventing an excessive increase in the element thickness of the dielectric ceramic layer between the internal electrodes 15 adjacent to each other in the lamination direction T.

### Second Example Embodiment

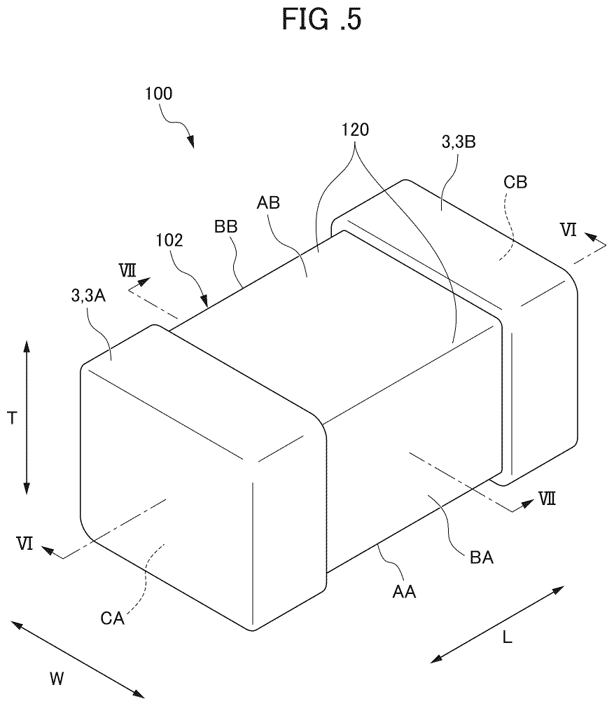

Next, a multilayer ceramic capacitor 100 according to a second example embodiment of the present invention will be described with reference to FIGS. 5 to 9. Hereinafter, differences from the first example embodiment will be mainly described, and the same components as those of the first example embodiment will be denoted by the same reference numerals and descriptions thereof will be omitted.

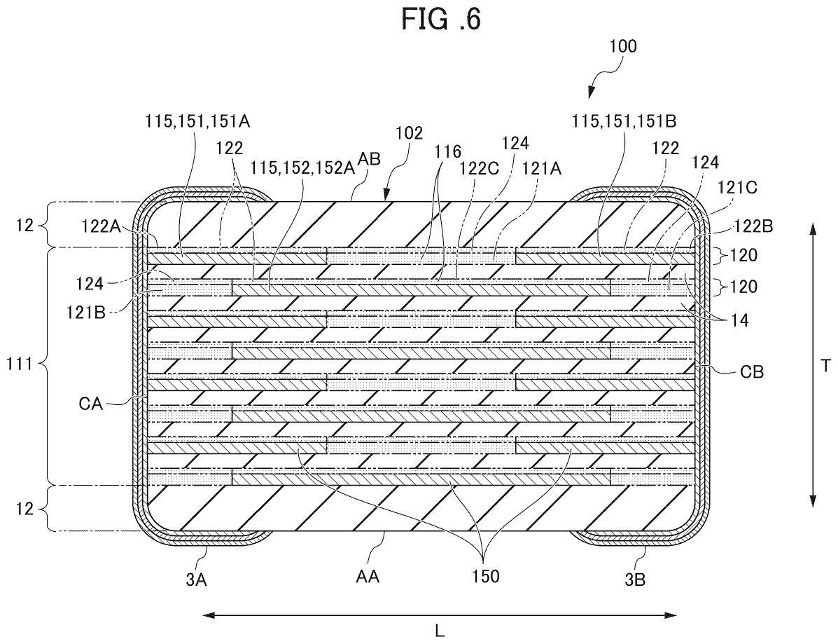

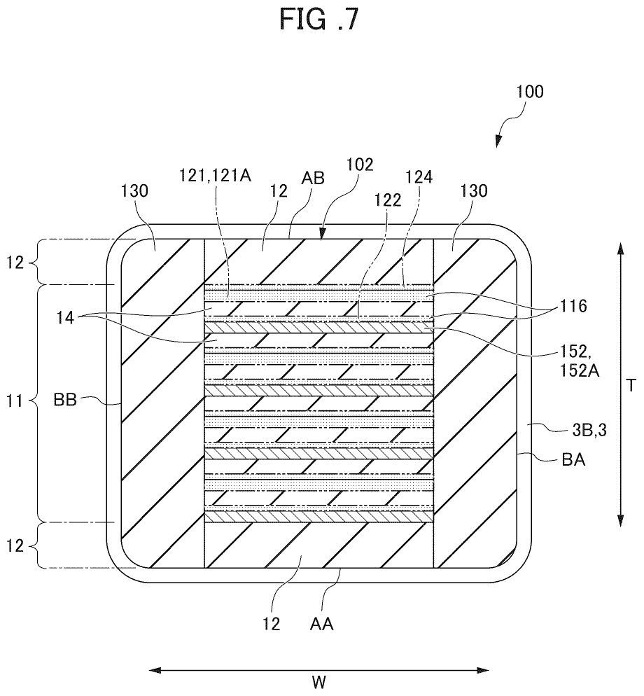

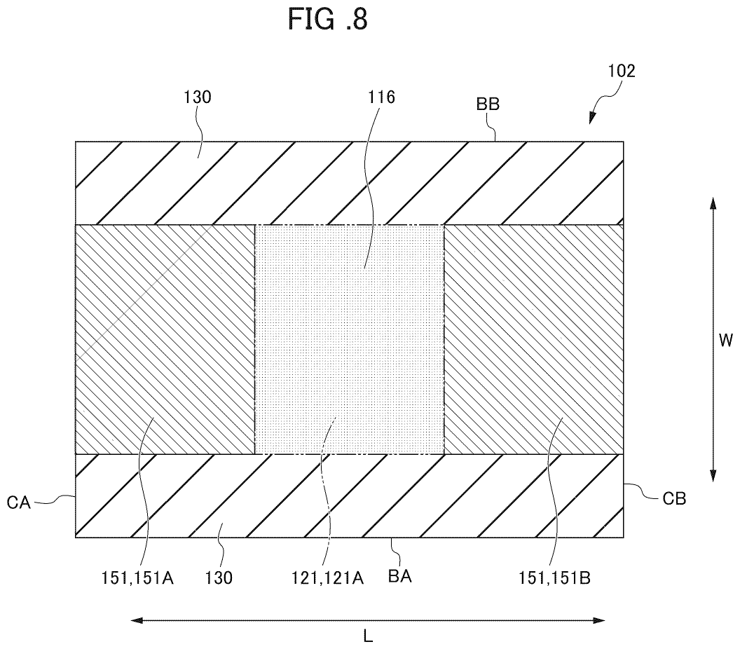

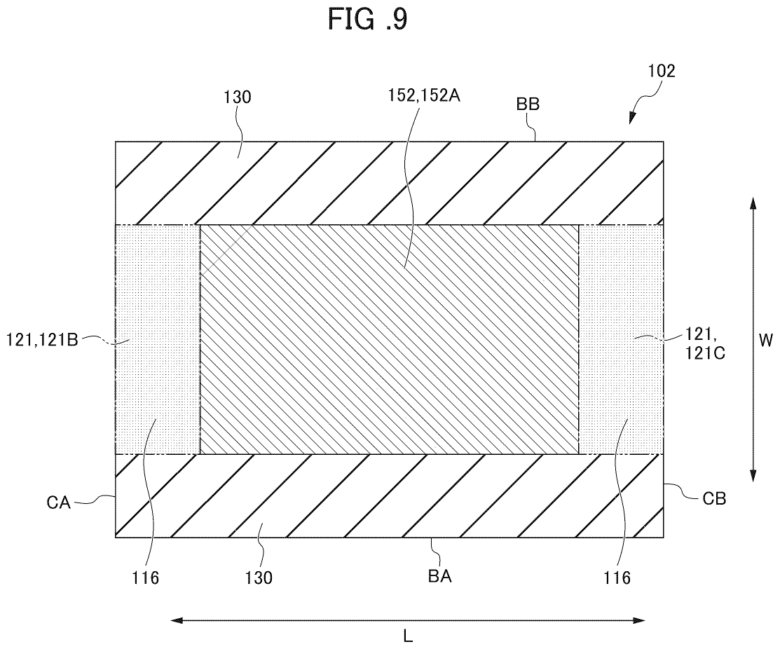

FIG. 5 is a schematic perspective view of the multilayer ceramic capacitor 100 according to the second example embodiment. FIG. 6 is a cross-sectional view of the multilayer ceramic capacitor 100 according to the second example embodiment taken along the line VI-VI in FIG. 5. FIG. 7 is a cross-sectional view of the multilayer ceramic capacitor 100 according to the second example embodiment taken along the line VII-VII in FIG. 5. FIG. 8 is a cross-sectional view along an extension internal electrode 151 of the multilayer ceramic capacitor 100 according to the second example embodiment. FIG. 9 is a cross-sectional view along a floating internal electrode 152 of the multilayer ceramic capacitor 100 according to the second example embodiment.

As shown in FIG. 5, the multilayer ceramic capacitor 100 according to the second example embodiment is, for example, a multilayer ceramic capacitor having a two-portion configuration.

As shown in FIG. 6, in the second example embodiment, the internal electrodes 115 each include extension internal electrodes 151 each exposed at one of the first end surface CA or the second end surface CB, and a floating internal electrode 152 not exposed at either the first end surface or the second end surface. The internal electrodes 115 are not exposed at the lateral surfaces B.

The extension internal electrodes 151 each include a first extension internal electrode 151A exposed at the first end surface CA and a second extension internal electrode 151B exposed at the second end surface CB. The first extension internal electrode 151A and the second extension internal electrode 151B are provided in the same interlayer region.

The floating internal electrode 152 includes a first floating internal electrode 152A. The first floating internal electrode 152A is provided in each of the interlayer regions 120 adjacent to the interlayer region 120 in which the extension internal electrodes 151 are provided in the lamination direction T. The interlayer regions 120 in which the extension internal electrodes 151 are provided and the interlayer regions 120 in which the first floating internal electrodes 152A are provided are alternately provided in the lamination direction T. The first floating internal electrodes 152A are each provided in a middle portion of a corresponding one of the interlayer regions 120 in the length direction L. An end portion of the first floating internal electrode 152A adjacent to the first end surface CA is opposed to the first extension internal electrode 151A, and an end portion of the first floating internal electrode 152A adjacent to the second end surface CB is opposed to the second extension internal electrode 151B.

In the second example embodiment, the interlayer regions 120 include first regions 121 each located between the end surfaces C, the extension internal electrodes 151, and the floating internal electrodes 152 adjacent to each other in the length direction L, and second regions 122 each overlapping the internal electrodes 150 provided in the interlayer region 120 when viewed in the lamination direction T.

As shown in FIGS. 7 to 9, the first region 121 includes a region (referred to as a “first region 121A”) located between the first extension internal electrode 151A and the second extension internal electrode 151B, a region (referred to as a “first region 121B”) located between the first end surface CA and the first floating internal electrode 152A, and a region (referred to as a “first region 121C”) located between the second end surface CB and the first floating internal electrode 152A. The first region 121 corresponds to a first region in claim 4.

The second region 122 includes a region (referred to as a “second region 122A”) located between the surface of the first extension internal electrode 151A adjacent to the second main surface and the main dielectric layer 14, a region (referred to as a “second region 122B”) located between the surface of the second extension internal electrode 151B adjacent to the second main surface and the main dielectric layer 14, and a region (referred to as a “second region 122C”) located between the surface of the first floating internal electrode 152A adjacent to the second main surface and the main dielectric layer 14.

The auxiliary dielectric layer 116 is provided in the first region 121A. With such a configuration, it is possible to reduce or prevent the generation of a step difference due to the internal electrode 150.

The auxiliary dielectric layer 116 is provided in each of the first region 121B and the first region 121C. With such a configuration, it is possible to reduce or prevent the generation of a step difference due to the internal electrode 150.

The auxiliary dielectric layer 116 is provided in each of the second region 122A, the second region 122B, and the second region 122C. With such a configuration, it is possible to easily provide the auxiliary dielectric layer 116 as compared with the case where the auxiliary dielectric layer 116 is provided only in the first region 121.

Similarly to the first example embodiment, the auxiliary dielectric layer 116 provided in the first region 121 and the auxiliary dielectric layer 116 provided in the second region 122 have the same main component of the dielectric ceramic. The main component of the dielectric ceramic of the auxiliary dielectric layer 116 is, for example, preferably one of CaTiO₃, CaZrO₃, or SrTiO_{3.}

In this case, with the auxiliary dielectric layer 116 provided in the first region 121A, it is possible to reduce or prevent the occurrence of dielectric breakdown between the first extension internal electrode 151A and the second extension internal electrode 151B. With the auxiliary dielectric layer 116 provided in the first region 121B and the first region 121C, it is possible to reduce or prevent the occurrence of dielectric breakdown between the external electrode 3 and the floating internal electrode 152. With the auxiliary dielectric layer 116 provided in the second region 122, it is possible to reduce or prevent the occurrence of dielectric breakdown between the internal electrodes 150 adjacent to each other in the lamination direction T.

The dimension in the lamination direction T of the auxiliary dielectric layer 116 provided in the second region 122 is, for example, preferably about 0.1 μm or more and preferably about 5.0 μm or less. The dimension of the main dielectric layer 14 in the lamination direction T is preferably greater than the dimension of the auxiliary dielectric layer 116 provided in the second region 122 in the lamination direction T. The internal electrodes 115 each preferably include, for example, Sn. Thus, it is possible to achieve the same or substantially the same advantageous effects as those of the first example embodiment.

Also in the second example embodiment, as in the first example embodiment, the dimension in the lamination direction T of the auxiliary dielectric layer 116 provided in the second region 122 is, for example, preferably about 0.1 μm or more and preferably about 5.0 μm or less. The dimension in the lamination direction T of the main dielectric layer 14 is preferably greater than the dimension in the lamination direction T of the auxiliary dielectric layer 116 provided in the second region 122. The main component of the dielectric ceramic of the main dielectric layer 14 is preferably a component having a higher permittivity than the main component of the dielectric ceramic of the auxiliary dielectric layer 116 provided in the second region 122. For example, it is preferable that the main component of the dielectric ceramic of the main dielectric layer 14 is BaTiO₃, and the main component of the dielectric ceramic of the auxiliary dielectric layer 116 provided in the second region 122 is one of CaTiO₃ or CaZrO₃. The internal electrodes 115 each preferably include, for example, Sn. Thus, it is possible to achieve the same or substantially the same advantageous effects as those of the first example embodiment.

The auxiliary dielectric layer 116 is also provided in a region of the first region 121 adjacent to the second main surface AB. Therefore, the interlayer regions 120 each include a remaining region 124 overlapping the first region 121 when viewed in the lamination direction T. This makes it possible to more suitably reduce or prevent deformation of the multilayer ceramic capacitor 100.

In the second example embodiment, each end portion of the inner layer portion 111 in the width direction W and each end portion of the internal electrode 150 in the width direction W are substantially flush with each other. The multilayer body 2 includes a pair of side gap portions 130 that sandwich the inner layer portion 111 in the width direction W. Therefore, in the multilayer body 2, no interlayer region 120 is provided in a region closer to the lateral surface B than the internal electrode 150. In other words, none of the interlayer regions 120 of the second example embodiment include a third region. However, the present invention is not limited to this, and the interlayer region 120 may include a third region as in the first example embodiment. At this time, the interlayer region 120 also includes a remaining region.

The multilayer ceramic capacitor 1 of the second example embodiment is manufactured by, for example, the following method. Since the steps after firing of the multilayer chip are the same or substantially the same as those of the above-described example embodiments, the description thereof will be omitted.

An electrically conductive paste for internal electrodes is printed on the dielectric sheet for the main dielectric layer 14. The electrically conductive paste is printed on the surface of the dielectric sheet such that a plurality of stripes are provided in the width direction of the stripes.

A predetermined number of dielectric sheets for the outer layer portion are laminated. Next, a predetermined number of dielectric sheets on which the electrically conductive paste is printed are laminated while being alternately shifted in the direction in which the plurality of electrically conductive pastes are printed adjacent to each other. Next, a predetermined number of dielectric sheets on which the electrically conductive paste is not printed are laminated. Thus, a mother multilayer body is obtained. The obtained mother multilayer body is pressed.

The pressed mother multilayer body is cut longitudinally and laterally in the lamination direction T. Thus, multilayer chips are obtained. More specifically, the mother multilayer body is cut in a direction parallel or substantially parallel to the length direction of the stripe and in the lamination direction T. At this time, the mother multilayer body is cut in the middle portion in the width direction of the stripe of the electrically conductive paste. Only one of the electrically conductive paste defining and functioning as the first extension internal electrode 151A or the electrically conductive paste defining and functioning as the second extension internal electrode 151B is exposed in each cross section generated by the cutting. The cross section corresponds to a surface defining and functioning as the end surface C of the multilayer body 2.

The mother multilayer body is cut in a direction perpendicular or substantially perpendicular to the length direction of the stripes and in the lamination direction T. Both of the electrically conductive paste for the extension internal electrode and the electrically conductive paste for the floating internal electrode are exposed in the cross section generated by the cutting. A dielectric sheet on which no electrically conductive paste is printed is attached to the cross section. The dielectric sheet provides the side gap portions 130. Thus, the multilayer chip to which the dielectric sheet for the side gap portions is attached is obtained.

Thus, the multilayer body 2 of the second example embodiment before firing is obtained.

As described above, the multilayer body 2 according to the first example embodiment may include side gap portions. In this case, the multilayer body 2 according to the first example embodiment can also be manufactured in the same or substantially the same manner as the multilayer body 102 according to the second example embodiment. Then, since the multilayer body 2 according to the first example embodiment includes the side gap portion on each lateral surface B thereof, no interlayer region 20 is provided adjacent to each lateral surface B of the internal electrode 15. As described above, also in the first example embodiment, the third region 23 is not required.

According to the present example embodiment, the multilayer ceramic capacitor 100 is a multilayer ceramic capacitor including a two-portion configuration. In this case, by providing the floating internal electrode 152 as the internal electrode 150, the multilayer ceramic capacitor 100 includes a configuration in which the counter electrode portion is divided into a plurality of portions. As a result, a plurality of capacitor components are provided between the opposing internal electrodes 150, and these capacitor components are connected in series. Therefore, the voltage applied to each capacitor component is reduced in value, and it is possible to increase the breakdown voltage of the multilayer ceramic capacitor 100.

Even if dielectric breakdown occurs between one of the extension internal electrodes 151 provided in the same interlayer region 120 and the floating internal electrode 152, the multilayer ceramic capacitor 100 can maintain its function as a capacitor unless the other extension internal electrode 151 and the floating internal electrode 152 are insulated from each other. Thus, it is possible to further increase the breakdown voltage of the multilayer ceramic capacitor 100.

According to the present example embodiment, it is possible to achieve the same or substantially the same advantageous effects as those of the first example embodiment also in the multilayer ceramic capacitor including such a two-portion configuration.

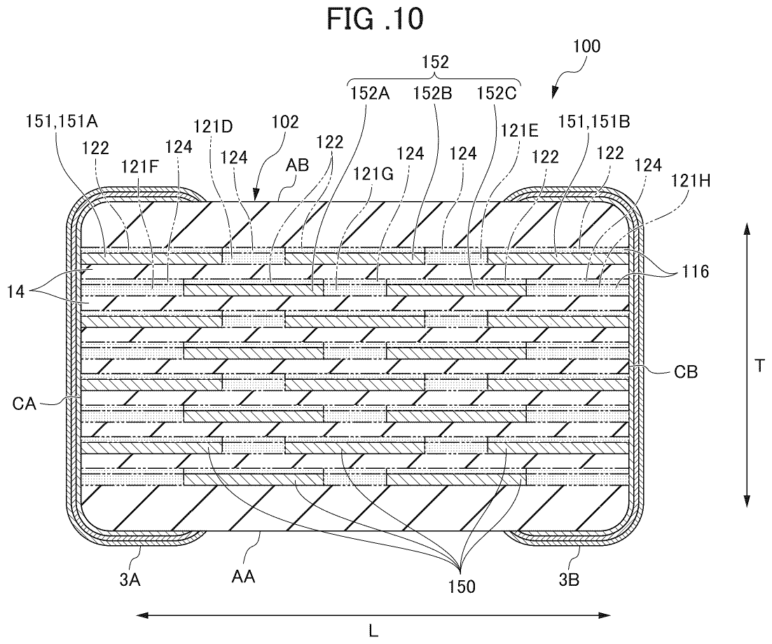

Next, a multilayer ceramic capacitor 100 according to a modified example of the second example embodiment of the present invention will be described with reference to FIGS. 10 to 12. Hereinafter, differences from the second example embodiment will be mainly described, and the same components as those of the first example embodiment will be denoted by the same reference numerals and descriptions thereof will be omitted.

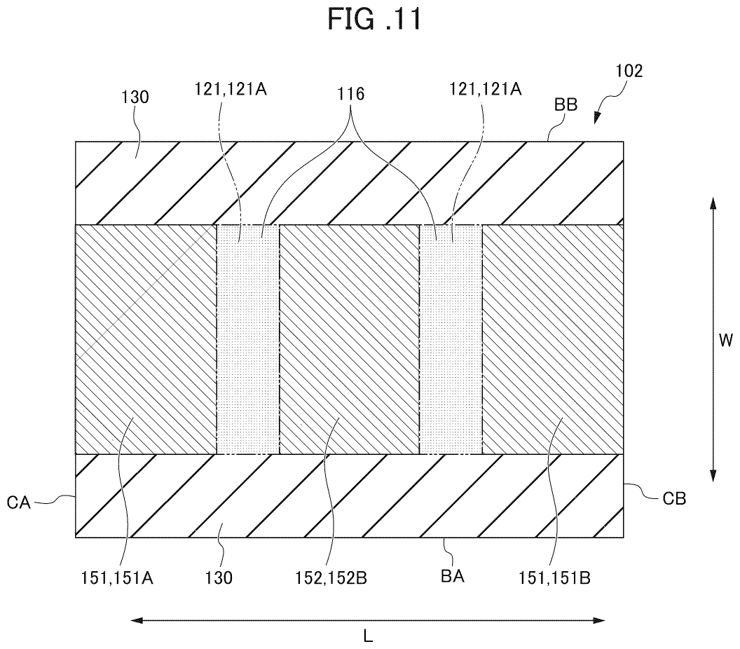

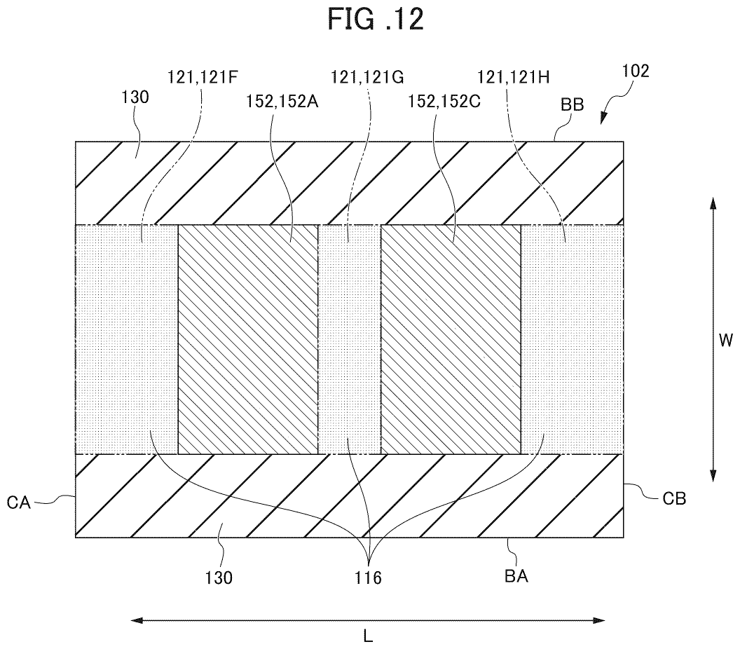

FIG. 10 is a cross-sectional view according to a modified example of the second example embodiment, and corresponds to FIG. 6 of the multilayer ceramic capacitor 100. FIG. 11 is a cross-sectional view along the extension internal electrode 151 and the second floating internal electrode 152B of the multilayer body 102 according to the modified example of the second example embodiment. FIG. 12 is a cross-sectional view along a first floating internal electrode 152A and a third floating internal electrode 152C of the multilayer body 102 according to the modified example of the second example embodiment.

As shown in FIG. 10, the multilayer ceramic capacitor 100 according to the present modified example is a multilayer ceramic capacitor including a three-portion configuration.

In the present modified example, the floating internal electrode 152 includes a first floating internal electrode 152A, a second floating internal electrode 152B, and a third floating internal electrode 152C.

The first floating internal electrode 152A and the third floating internal electrode 152C are provided in the interlayer region 120 adjacent to the interlayer region 120 in which the first extension internal electrode 151A and the second extension internal electrode 151B are provided in the lamination direction T. The first floating internal electrode 152A and the third floating internal electrode 152C are provided at a predetermined interval in the length direction L.

The second floating internal electrode 152B is provided in the same interlayer region 120 as the first extension internal electrode 151A and the second extension internal electrode 151B. The first extension internal electrode 151A, the second floating internal electrode 152B, and the second extension internal electrode 151B are provided in this order in the length direction L at a predetermined interval.

The interlayer region 120 in which the extension internal electrode 151 and the second floating internal electrode 152B are provided and the interlayer region 120 in which the first floating internal electrode 152A and the third floating internal electrode 152C are provided are alternately provided in the lamination direction T. The end portion of the first floating internal electrode 152A adjacent to the first end surface CA is opposed to the first extension internal electrode 151A, and the end portion adjacent to the second end surface CB is opposed to the second floating internal electrode 152B. The end portion of the third floating internal electrode 152C adjacent to the first end surface CA is opposed to the second floating internal electrode 152B, and the end portion adjacent to the second end surface CB is opposed to the first extension internal electrode 151A.

As shown in FIGS. 11 and 12, in the present modified example, the first region 121 includes a region (referred to as a “first region 121D”) located between the first extension internal electrode 151A and the second floating internal electrode 152B, a region (referred to as a “first region 121E”) located between the second floating internal electrode 152B and the second extension internal electrode 151B, a region (referred to as a “first region 121F”) located between the first end surface CA and the first floating internal electrode 152A, a region (referred to as a “first region 121G”) located between the first floating internal electrode 152A and the third floating internal electrode 152C, and a region (referred to as a “first region 121H”) located between the third floating internal electrode 152C and the second end surface CB.

The auxiliary dielectric layer 116 is provided in the first region 121D, the first region 121E, and the first region 121G. With such a configuration, it is possible to reduce or prevent the generation of a step difference due to the internal electrode 150. In addition, it is possible to reduce or prevent the occurrence of dielectric breakdown between the internal electrodes 150 adjacent to each other in the length direction L.

The auxiliary dielectric layer 116 is provided in the first region 121F and the first region 121G. With such a configuration, it is possible to reduce or prevent the generation of a step difference due to the internal electrode 150. In addition, it is possible to reduce or prevent the occurrence of dielectric breakdown between the external electrode 3 and the floating internal electrode 152.

According to the present modified example, the multilayer ceramic capacitor 100 includes a three-portion configuration. Thus, it is possible to achieve further increase in the breakdown voltage of the multilayer ceramic capacitor 100.

According to the present modified example, it is possible to achieve the same or substantially the same advantageous effects as those of the first example embodiment also in the multilayer ceramic capacitor 100 including the three-portion configuration. The same applies to a multilayer ceramic capacitor including a configuration including four or more portions.

### Third Example Embodiment

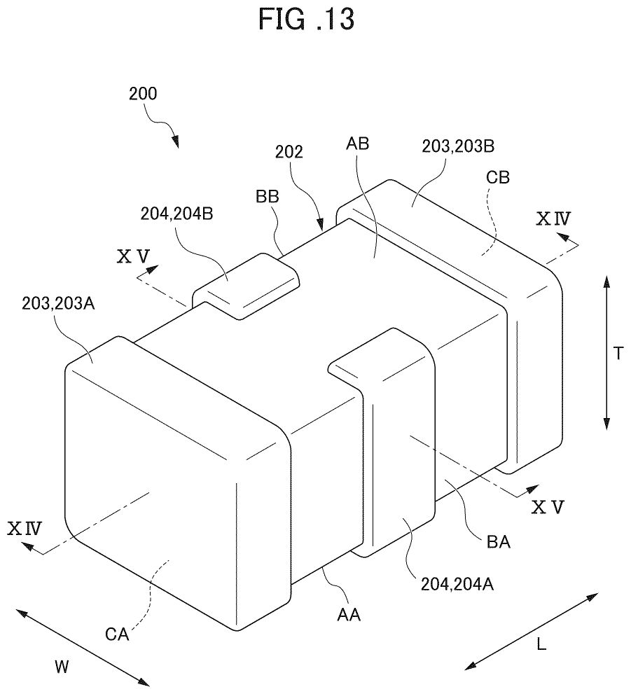

Next, a multilayer ceramic capacitor 200 according to a third example embodiment of the present invention will be described with reference to FIGS. 13 to 17. Hereinafter, differences from the first example embodiment will be mainly described, and the same components as those of the first example embodiment will be denoted by the same reference numerals and descriptions thereof will be omitted.

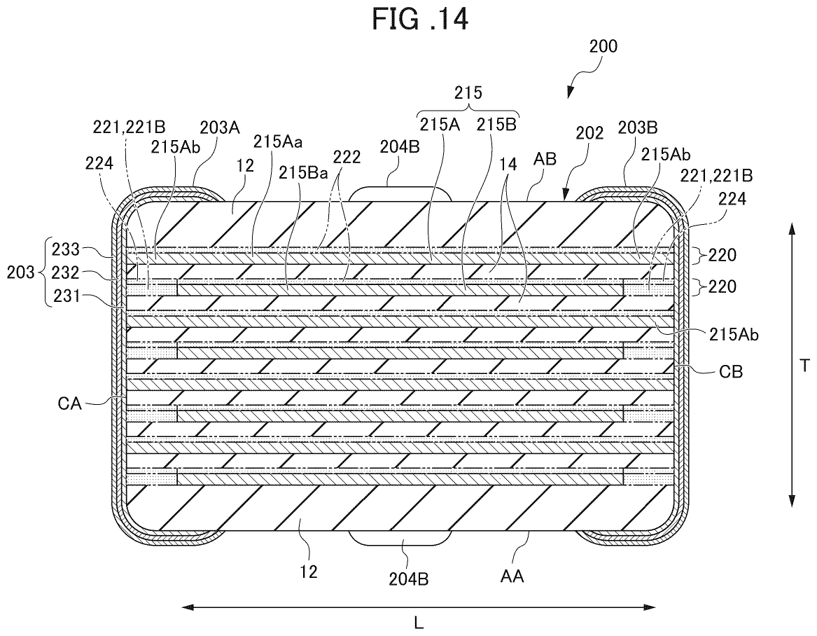

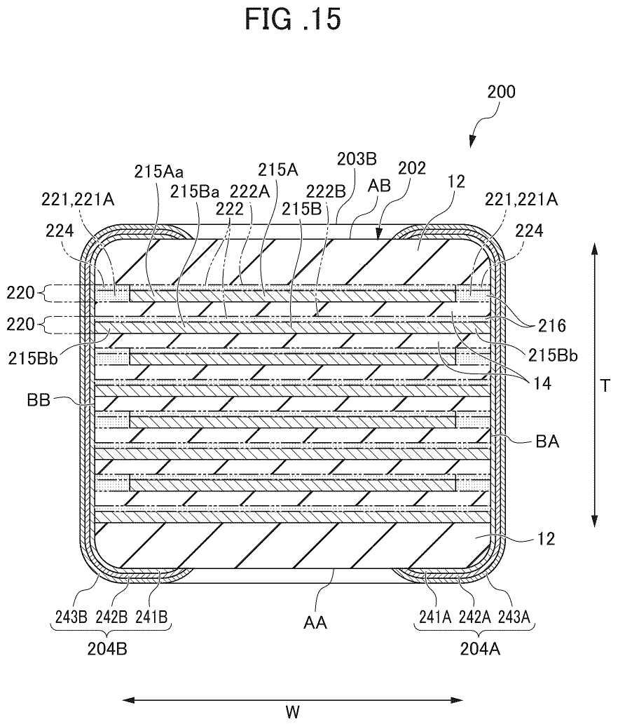

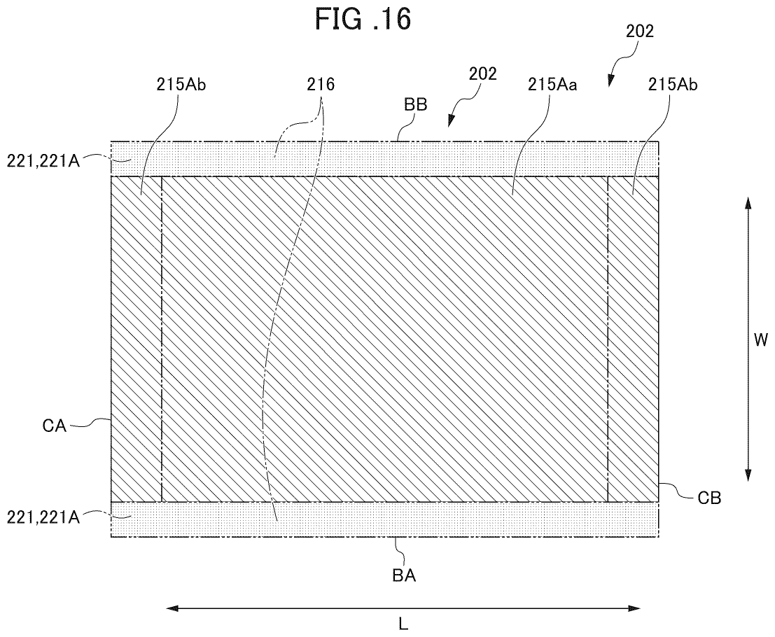

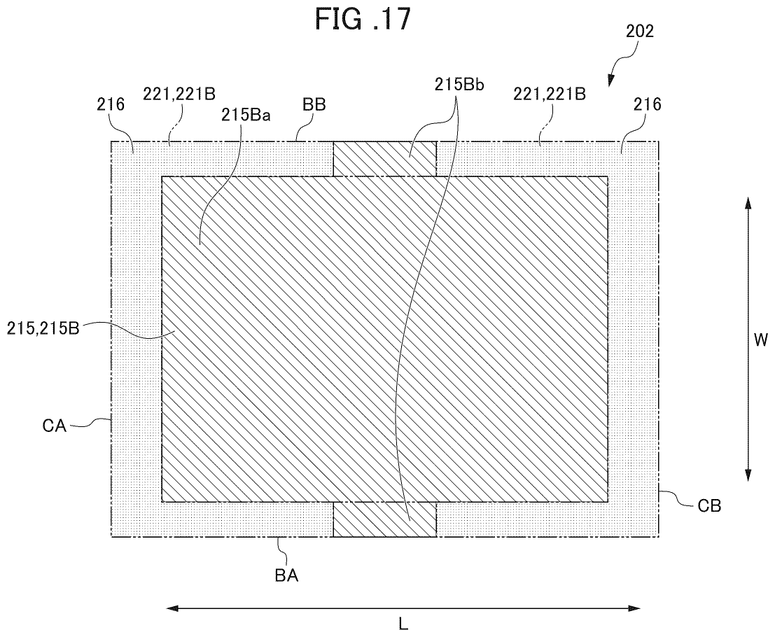

FIG. 13 is a schematic perspective view of a multilayer ceramic capacitor 200 according to the third example embodiment. FIG. 14 is a cross-sectional view of the multilayer ceramic capacitor 200 according to the third example embodiment taken along the line XIV-XIV in FIG. 13. FIG. 15 is a cross-sectional view of the multilayer ceramic capacitor 200 according to the third example embodiment taken along the line XV-XV in FIG. 13. FIG. 16 is a cross-sectional view of the multilayer ceramic capacitor 200 according to the third example embodiment taken along an end surface internal electrode 215A. FIG. 17 is a cross-sectional view of the multilayer ceramic capacitor 200 according to the third example embodiment taken along a lateral surface internal electrode 215B.

In the present example embodiment, in the multilayer ceramic capacitor 200, a direction orthogonal or substantially orthogonal to the lamination direction T and in which the pair of end surface external electrodes 203 are provided is defined as a length direction L.

In the third example embodiment, the multilayer ceramic capacitor 200 is, for example, a multilayer ceramic capacitor 200 including a three-terminal configuration. As shown in FIG. 13, the multilayer ceramic capacitor 200 includes a pair of end surface external electrodes 203 each provided on a corresponding one of both end surfaces C of the multilayer body 202 in the length direction L, and a pair of lateral surface external electrodes 204 each provided on a corresponding one of both lateral surfaces B of the multilayer body 202 in the width direction W.

As shown in FIGS. 14 and 15, in the third example embodiment, the internal electrodes 215 include a plurality of end surface internal electrodes 215A and a plurality of lateral surface internal electrodes 215B, which are alternately provided. The end surface internal electrodes 215A and the lateral surface internal electrodes 215B may be collectively referred to as “internal electrodes 215” when it is not particularly necessary to distinguish between them.

The end surface internal electrodes 215A extend between both end surfaces C in the length direction L of the multilayer body 202 and are exposed at the respective end surfaces C. The end surface internal electrodes 215A are separated from both lateral surfaces B in the width direction W. The end surface internal electrodes 215A each include a first counter portion 215Aa opposed to the lateral surface internal electrode 215B adjacent in the lamination direction T, and first extension portions 215Ab each extending from the first counter portion 215Aa and each exposed at a corresponding one of the end surfaces C. Specifically, the first counter portion 215Aa is located in a middle portion between the end surfaces C.

The lateral surface internal electrodes 215B extend between both lateral surfaces B in the width direction W of the multilayer body 202 and are exposed at the respective lateral surfaces B. The lateral surface internal electrodes 215B are slightly smaller than the multilayer body 202 and are spaced apart from both end surfaces C in the length direction L by a certain distance. The lateral surface internal electrodes 215B each include a second counter portion 215Ba opposed to the end surface internal electrode 215A (first counter portion 215Aa) adjacent in the lamination direction T, and a second extension portion 215Bb extending from a corresponding one of the second counter portions 215Ba and exposed at each of the lateral surfaces B. Specifically, the second counter portion 215Ba is located in the middle portion between the lateral surfaces B.

The pair of end surface external electrodes 203 are each provided on a corresponding one of the end surfaces C of the multilayer body 202. The first extension portions 215Ab are each connected to a corresponding one of the end surface external electrodes 203. Each of the end surface external electrodes 203 covers not only a corresponding one of the end surfaces C, but also a portion of each main surface A and each lateral surface B adjacent to the corresponding one of the end surfaces C. Each of the end surface external electrodes 203 includes, for example, a base electrode layer 231, a Ni plated layer 232 provided on the base electrode layer 231, and a Sn plated layer 233 provided on the Ni plated layer 232.

The pair of lateral surface external electrodes 204 are each provided on a corresponding one of the lateral surfaces B of the multilayer body 202. The second extension portions 215Bb are connected to each of the lateral surface external electrodes 204. Each of the lateral surface external electrodes 204 covers not only a corresponding one of the lateral surfaces B, but also a portion of each main surface A adjacent to each lateral surface B. Each of the lateral surface external electrodes 204 includes, for example, a base electrode layer 241, a Ni plated layer 242 provided on the base electrode layer 241, and a Sn plated layer 243 provided on the Ni plated layer 242. The end surface external electrodes 203 and the lateral surface external electrodes 204 may be collectively referred to as “external electrodes 203 and 204”.

In the third example embodiment, each of the interlayer regions 220 includes a first region 221 located between any of the lateral surfaces B or the end surfaces C and the internal electrode 215, and a second region 222 overlapping the internal electrode 215 provided in the interlayer region 220 when viewed in the lamination direction T.

The first regions 221 include a region (referred to as a “first region 221A”) located between any of the lateral surfaces B and the end surface internal electrode 215A, and a region (referred to as a “first region 221B”) located between any of the lateral surfaces B and the end surfaces C, and the lateral surface internal electrode 215B. The first region 221 corresponds to a first region in claim 5.

The second region 222 includes a region (referred to as a “second region 222A”) adjacent to the surface of the end surface internal electrode 215A adjacent to the second main surface AB and a region (referred to as a “second region 222B”) adjacent to the surface of the lateral surface internal electrode 215B adjacent to the second main surface AB.

In the third example embodiment, the auxiliary dielectric layer 216 is provided in both of the first region 221 and the second region 222.

As in the above example embodiments, the main components of the dielectric ceramic of the auxiliary dielectric layer 216 and the main component of the dielectric ceramic of the main dielectric layer 14 are different from each other. The main component of the dielectric ceramic providing the main dielectric layer 14 is, for example, BaTiO₃. The main component of the dielectric ceramic of the auxiliary dielectric layer 216 is, for example, any one of CaTiO₃, CaZrO₃, or SrTiO₃. The auxiliary dielectric layer 216 provided in the first region 221 and the auxiliary dielectric layer 216 provided in the second region 222 have the same main component of the dielectric ceramic. The main component of the dielectric ceramic of the main dielectric layer 14 has a higher permittivity than the main component of the dielectric ceramic of the auxiliary dielectric layer 216 provided in the second region 222.

The auxiliary dielectric layer 216 is provided in the first region 221A. In this case, the auxiliary dielectric layer 216 is provided between the end surface internal electrode 215A and each lateral surface B. With such a configuration, it is possible to reduce or prevent the generation of a step difference due to the internal electrode 215. In addition, it is possible to reduce or prevent the occurrence of dielectric breakdown between the end surface internal electrode 215A and the lateral surface external electrode 204.

The auxiliary dielectric layer 216 is provided in the first region 221B. In this case, the auxiliary dielectric layer 216 is provided between the lateral surface internal electrode 215B (the second counter portion 215Ba) and each end surface C. With such a configuration, it is possible to reduce or prevent the occurrence of dielectric breakdown between the lateral surface internal electrode 215B (the second counter portion 215Ba) and the end surface external electrode 203. In addition, an auxiliary dielectric layer 216 is provided between the lateral surface internal electrode 215B (second counter portion 215Ba) and each lateral surface B. With such a configuration, for example, it is possible to reduce or prevent the occurrence of dielectric breakdown between the lateral surface internal electrode 215B (the second counter portion 215Ba) and the lateral surface external electrode 204. In addition, it is possible to reduce or prevent the generation of a step difference due to the internal electrode 215.

The main dielectric layer 14 and the auxiliary dielectric layer 216 are provided between the end surface internal electrodes 215A and the lateral surface internal electrodes 215B, which are adjacent to each other in the lamination direction T. With such a configuration, it is possible to suitably reduce or prevent the occurrence of dielectric breakdown between the internal electrodes 215 adjacent to each other in the lamination direction T. In addition, it is possible to provide the auxiliary dielectric layer 216 easily as compared with the case where the auxiliary dielectric layer 216 is provided only in the first region 221.

The auxiliary dielectric layer 216 is also provided in a region of the first region 221 adjacent to the second main surface AB. Therefore, the interlayer region 220 includes a remaining region 224 overlapping the first region 221 when viewed in the lamination direction T. This makes it possible to more suitably reduce or prevent deformation of the multilayer ceramic capacitor 200.

Also in the third example embodiment, as in the first example embodiment, the dimension of the auxiliary dielectric layer 216 provided in the second region 222 in the lamination direction T is, for example, preferably about 0.1 μm or more and about 5.0 μm or less. The dimension of the main dielectric layer 14 in the lamination direction T is preferably greater than the dimension of the auxiliary dielectric layer 216 provided in the second region 222 in the lamination direction T. The internal electrode 215 preferably includes Sn, for example. Thus, it is possible to achieve the same or substantially the same advantageous effects as those of the first example embodiment.

The main component of the dielectric ceramic of the dielectric layer may be different between the auxiliary dielectric layer 216 provided in the interlayer region 220 in which the lateral surface internal electrode 215B is provided and the auxiliary dielectric layer 216 provided in the interlayer region 220 in which the end surface internal electrode 215A is provided. As such, the main component of the dielectric ceramic of the auxiliary dielectric layer 216 may vary depending on the interlayer region 220. This makes it possible to optimize the function of the auxiliary dielectric layer 216 according to the shape, function, and the like of each internal electrode. However, in the interlayer region 220, the auxiliary dielectric layer 216 provided in the first region 221 and the auxiliary dielectric layer 216 provided in the second region 222 have the same main component of the dielectric ceramic.

In the third example embodiment, the manufacturing method of the multilayer ceramic capacitor 200 is the same or substantially the same as that of the first example embodiment. However, the printing pattern of the internal electrodes 215 is appropriately changed. The method for providing the lateral surface external electrode 204 (specifically, the base electrode layer 241) is different from the method for providing the external electrode 3 of the first example embodiment. The base electrode layer 241 is provided by, for example, a method for applying an electrically conductive paste by extruding the electrically conductive paste from a slit or a roller transfer method.

According to the present example embodiment, it is possible to achieve the following advantageous effects.

According to the present example embodiment, the multilayer ceramic capacitor 200 is a three-terminal multilayer ceramic capacitor. With such a configuration, the ESL of the multilayer ceramic capacitor can be reduced, so that it is possible to suitably use the multilayer ceramic capacitor 200 as a capacitor for noise countermeasures or decoupling.

According to the present example embodiment, it is possible to achieve the same or substantially the same advantageous effects as those of the first example embodiment also in the three-terminal multilayer ceramic capacitor 200.

### Fourth Example Embodiment

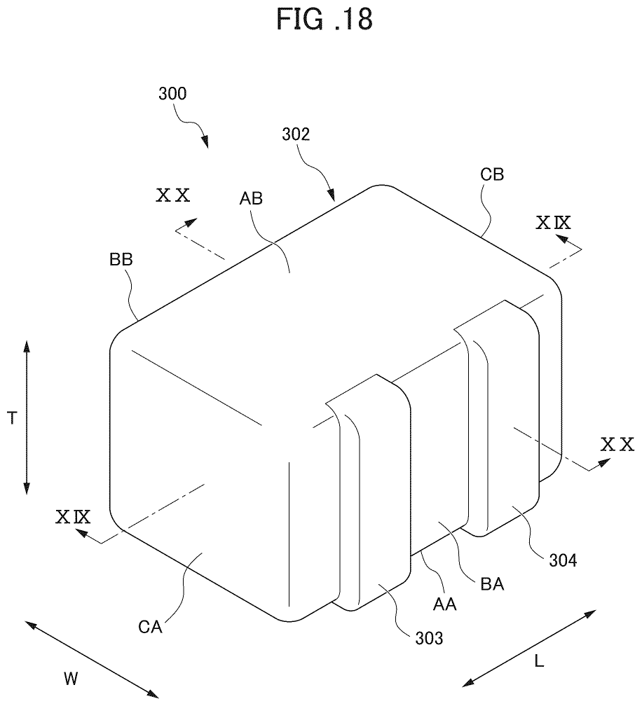

Next, a multilayer ceramic capacitor 300 according to a fourth example embodiment of the present invention will be described with reference to FIGS. 18 to 22. Hereinafter, differences from the first example embodiment will be mainly described, and the same components as those of the first example embodiment will be denoted by the same reference numerals and descriptions thereof will be omitted.

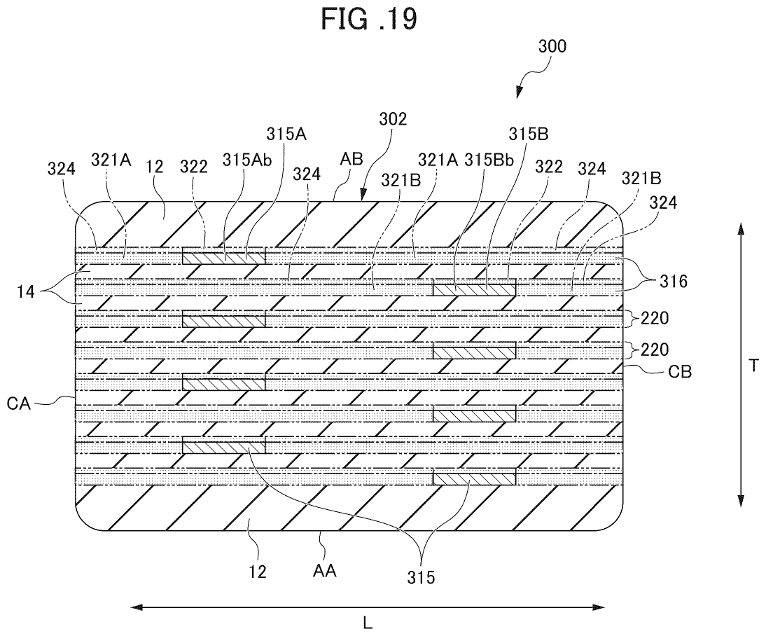

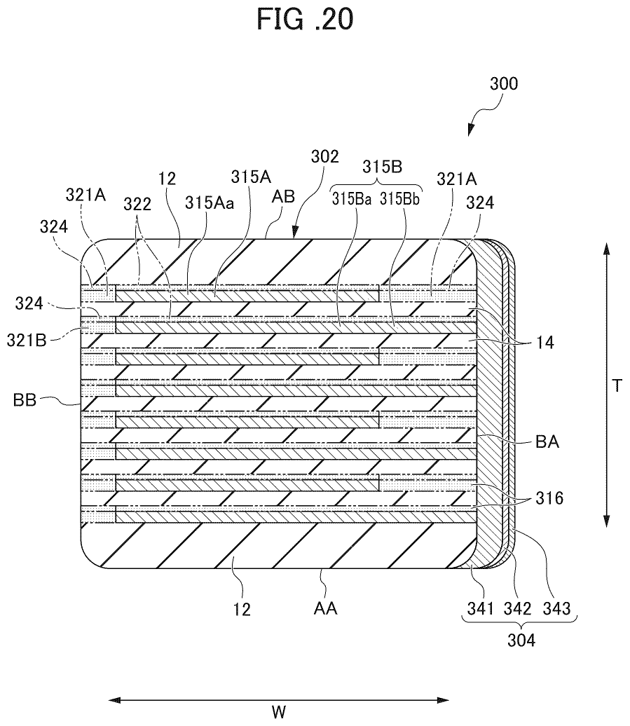

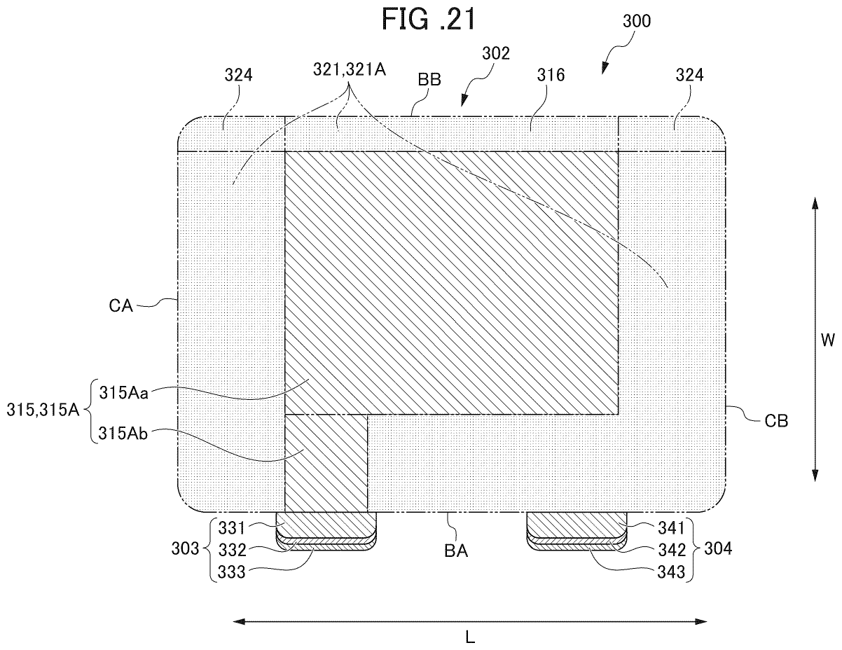

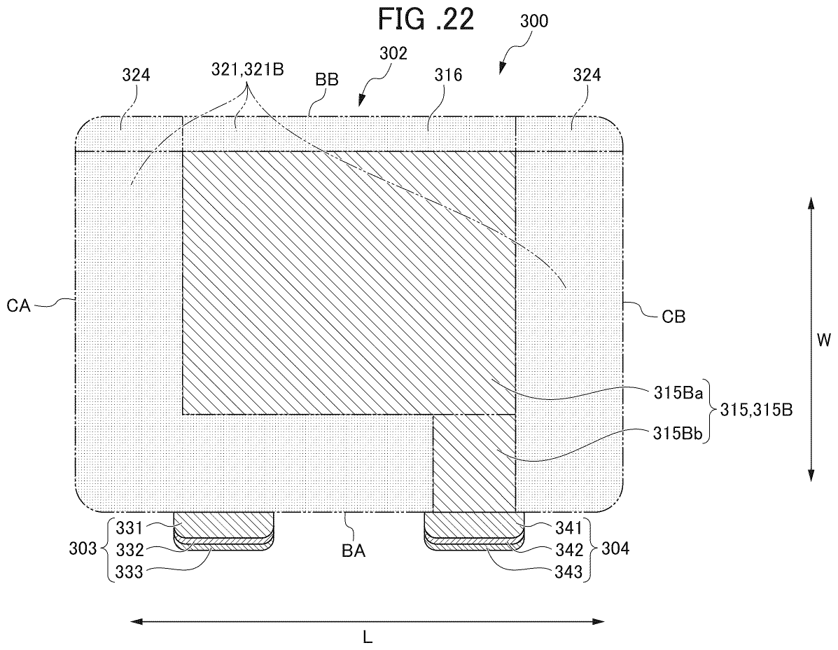

FIG. 18 is a schematic perspective view of a multilayer ceramic capacitor 300 according to the fourth example embodiment. FIG. 19 is a cross-sectional view of the multilayer ceramic capacitor 300 according to the fourth example embodiment taken along the line XIX-XIX in FIG. 18. FIG. 20 is a cross-sectional view of the multilayer ceramic capacitor 300 according to the fourth example embodiment taken along the line XX-XX in FIG. 18. FIG. 21 is a cross-sectional view of the multilayer ceramic capacitor 300 according to the fourth example embodiment taken along a first end surface-lateral surface internal electrode 315A. FIG. 22 is a cross-sectional view of the multilayer ceramic capacitor 300 according to the fourth example embodiment taken along a second end surface-lateral surface internal electrode 315B.

In the present example embodiment, in the multilayer ceramic capacitor 300, a direction orthogonal or substantially orthogonal to the lamination direction T is defined as a length direction L. A direction orthogonal or substantially orthogonal to both of the length direction L and the lamination direction T is defined as a width direction W.

The multilayer ceramic capacitor 300 according to the fourth example embodiment is a multilayer ceramic capacitor including two external electrodes on the first lateral surface BA of the multilayer body. When mounted on a mounting substrate (not shown), the multilayer ceramic capacitor 300 is mounted with the first lateral surface BA opposed to the mounting substrate.

In the fourth example embodiment, internal electrodes 315 include first end surface-lateral surface internal electrodes 315A each extending toward a region of the first lateral surface BA adjacent to the first end surface CA, and second end surface-lateral surface internal electrodes 315B each extending toward a region of the first lateral surface BA adjacent to the second end surface CB.

The first end surface-lateral surface internal electrodes 315A each include a first counter portion 315Aa opposed to the second end surface-lateral surface internal electrode 315B adjacent in the lamination direction T, and a first extension portion 315Ab extending from the first counter portion 315Aa and exposed at a region of the first lateral surface BA adjacent to the first end surface CA.

The first counter portion 315Aa is separated from both lateral surfaces B and both end surfaces C. The first extension portion 315Ab is separated from both second lateral surface B. Each of the first counter portion 315Aa and the first extension portion 315Ab has a rectangular or substantially rectangular shape when viewed in the lamination direction T. The first end surface-lateral surface internal electrode 315A has an L-shape or a substantially L-shape when viewed in the lamination direction T.

The second end surface-lateral surface internal electrodes 315B each include a second counter portion 315Ba opposed to the first end surface-lateral surface internal electrode 315A (specifically, the first counter portion 315Aa) adjacent in the lamination direction T, and a second extension portion 315Bb extending from the second counter portion 315Ba and exposed at a region of the first lateral surface BA adjacent to the second end surface CB.

The second counter portion 315Ba is separated from both lateral surfaces B and both end surfaces C. The second extension portion 315Bb is separated from both lateral surfaces B. Each of the second counter portion 315Ba and the second extension portion 315Bb has a rectangular or substantially rectangular shape when viewed in the lamination direction T. The second end surface-lateral surface internal electrode 315B has an L-shape or a substantially L-shape when viewed in the lamination direction T. In addition, the first extension portion 315Ab and the second extension portion 315Bb do not overlap each other when viewed in the lamination direction T.

In the fourth example embodiment, the multilayer ceramic capacitor 300 includes a first end surface-lateral surface external electrode 303 provided on the first lateral surface BA adjacent to the first end surface CA, and a second end surface-lateral surface external electrode 304 provided on the first lateral surface BA adjacent to the second end surface CB. In addition, the first end surface-lateral surface external electrode 303 and the second end surface-lateral surface external electrode 304 may be collectively referred to as “lateral surface external electrodes 303 and 304” when it is not particularly necessary to distinguish between them.

The first extension portion 315Ab is connected to the first end surface-lateral surface external electrode 303. The second extension portion 315Bb is connected to the second end surface-lateral surface external electrode 304. The lateral surface external electrodes 303 and 304 cover not only the first lateral surface BA, but also a portion of the main surface A adjacent to the first lateral surface BA. The first end surface-lateral surface external electrode 303 includes, for example, a base electrode layer 331, a Ni plated layer 332 provided on the base electrode layer 331, and a Sn plated layer 333 provided on the Ni plated layer 332.

In the fourth example embodiment, the interlayer regions 220 each include a first region 321 located between any of the lateral surfaces B and the end surfaces C, and the internal electrode 315, and a second region 322 overlapping the internal electrode 315 provided in the interlayer region 220 when viewed in the lamination direction T. The first region 321 corresponds to a first region.

An auxiliary dielectric layer 316 is provided in the first region 321 and the second region 322. The auxiliary dielectric layer 316 is also provided in a region of the first region 321 adjacent to the second main surface AB. Therefore, the interlayer region 220 includes a remaining region 324 overlapping the first region 321 when viewed in the lamination direction T.

As in the first example embodiment, the main component of the dielectric ceramic of the auxiliary dielectric layer 316 and the main component of the dielectric ceramic of the main dielectric layer 14 are different from each other. The main component of the dielectric ceramic of the main dielectric layer 14 is, for example, BaTiO₃. The main component of the dielectric ceramic of the auxiliary dielectric layer 316 is, for example, any one of CaTiO₃, CaZrO₃, or SrTiO₃. The auxiliary dielectric layer 316 provided in the first region 321 and the auxiliary dielectric layer 316 provided in the second region 322 have the same main component of the dielectric ceramic. The main component of the dielectric ceramic of the main dielectric layer 14 has a higher permittivity than the main component of the dielectric ceramic of the auxiliary dielectric layer 316 provided in the second region 322.

The auxiliary dielectric layer 316 is provided between each of the end surfaces C, and each of the first extension portion 315Ab and the second extension portion 315Bb. The auxiliary dielectric layer 316 is provided between the first lateral surface BA, and each of the first counter portion 315Aa and the second counter portion 315Ba. With such a configuration, it is possible to reduce or prevent the generation of a step difference due to the internal electrode 315. In addition, it is possible to reduce or prevent the occurrence of dielectric breakdown between the internal electrode 315 and the lateral surface external electrodes 303 and 304.

The auxiliary dielectric layer 316 is provided between the first counter portion 315Aa and the second counter portion 315Ba, and each end surface C. The auxiliary dielectric layer 316 is provided between the second lateral surface BB, and the first counter portion 315Aa and the second counter portion 315Ba. With such a configuration, it is possible to reduce or prevent the generation of a step difference due to the internal electrode 315. In addition, it is possible to reduce or prevent the occurrence of dielectric breakdown in the peripheral portion of the internal electrode 315.

The main dielectric layer 14 and the auxiliary dielectric layer 316 are provided between the first end surface-lateral surface internal electrode 315A and the second end surface-lateral surface internal electrode 315B, which are adjacent to each other in the lamination direction T. With such a configuration, it is possible to suitably reduce or prevent the occurrence of dielectric breakdown between the internal electrodes 315 adjacent to each other in the lamination direction T. In addition, it is possible to provide the auxiliary dielectric layer 316 easily as compared with the case where the auxiliary dielectric layer 316 is provided only in the first region 321.

Also in the fourth example embodiment, as in the first example embodiment, the dimension of the auxiliary dielectric layer 316 provided in the second region 322 in the lamination direction T is, for example, preferably about 0.1 μm or more and about 5.0 μm or less. The dimension of the main dielectric layer 14 in the lamination direction T is preferably greater than the dimension of the auxiliary dielectric layer 316 provided in the second region 322 in the lamination direction T. The internal electrode 315 preferably includes Sn, for example. With such a configuration, it is possible to achieve the same or substantially the same advantageous effects as those of the first example embodiment.

The first end surface-lateral surface external electrode 303 and the second end surface-lateral surface external electrode 304 may be provided on the second lateral surface BB. The first end surface-lateral surface internal electrode 315A and the second end surface-lateral surface internal electrode 315B may extend toward the second lateral surface BB.

In the fourth example embodiment, the manufacturing method of the multilayer ceramic capacitor 300 is the same or substantially the same as that of the first example embodiment. However, the printing pattern of the internal electrode 315 is appropriately changed. The method for providing the lateral surface external electrodes 303 and 304 (specifically, the base electrode layers 331 and 341) is different from that of the first example embodiment. The base electrode layers 331 and 341 are provided by, for example, a method of applying an electrically conductive paste by extruding the electrically conductive paste from a slit or a roller transfer method.

According to the present example embodiment, the same or substantially the same advantageous effects as those of the first example embodiment can be obtained.

Although example embodiments of the present invention have been described above, the present invention is not limited to the above-described example embodiments, and various changes and modifications can be made.

In each of the above-described example embodiments, the auxiliary dielectric layer is located between the surface of the internal electrode adjacent to the second main surface and the main dielectric layer, and the second region is located between the surface of the internal electrode adjacent to the second main surface and the main dielectric layer, but the present invention is not limited thereto. The auxiliary dielectric layer may be located between the surface of the internal electrode adjacent to the first main surface and the main dielectric layer, and the second region may be located between the surface of the internal electrode adjacent to the first main surface AA and the main dielectric layer. In this case, in the manufacturing process of the multilayer ceramic capacitor, after the dielectric paste forming the auxiliary dielectric layer is provided on the dielectric sheet functioning as the main dielectric layer, the electrically conductive paste forming the internal electrode is printed on the dielectric sheet on which the dielectric paste is provided. The auxiliary dielectric layers may be provided on both sides of the internal electrodes in the lamination direction T, and the second regions may be provided on both sides of the internal electrodes in the lamination direction T.

In each of the above-described example embodiments, the auxiliary dielectric layer covers the entire or substantially the entire area of the surface of the main dielectric layer adjacent to the second main surface AB where the internal electrodes are provided, and covers the entire or substantially the entire area of the surface of the internal electrode adjacent to the second main surface AB, but the present invention is not limited thereto. It is preferable that the auxiliary dielectric layer provided in the second region covers to a certain extent or more the surface of the internal electrode adjacent to the auxiliary dielectric layer. A value obtained by dividing the dimension in the length direction L of the portion of the surface of the internal electrode covered with the auxiliary dielectric layer provided in the second region in the reference cross section by the dimension in the length direction L of the internal electrode in the reference cross section is, for example, preferably about 0.8 or more, and more preferably about 0.9 or more. With such a configuration, it is possible to suitably facilitate providing the auxiliary dielectric layer and reduce or prevent the occurrence of dielectric breakdown.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion including a plurality of main dielectric layers and a plurality of internal electrodes laminated, a first main surface and a second main surface opposed to each other in a lamination direction, a first end surface and a second end surface opposed to each other in a length direction orthogonal or substantially orthogonal to the lamination direction, a first lateral surface and a second lateral surface opposed to each other in a width direction orthogonal or substantially orthogonal to both the lamination direction and the length direction, and a pair of outer layer portions sandwiching the inner layer portion in the lamination direction;
a first external electrode on the multilayer body; and
a second external electrode on the multilayer body; wherein the multilayer body includes a plurality of interlayer regions each sandwiched between a corresponding one of the plurality of main dielectric layers and a corresponding one of the outer layer portions adjacent to each other in the lamination direction, and a plurality of auxiliary dielectric layers each provided in a corresponding one of the interlayer regions;
each of the plurality of interlayer regions includes a first region located between the first end surface and a corresponding one of the plurality of internal electrodes, and a second region overlapping a corresponding one of the plurality of internal electrodes provided in a corresponding one of the plurality of interlayer regions when viewed in the lamination direction;
each of the plurality of auxiliary dielectric layers is provided in both of the first region and the second region;
each of the plurality of auxiliary dielectric layers provided in the first region and each of the plurality of auxiliary dielectric layers provided in the second region include a same main component of a dielectric ceramic; and
each of the plurality of auxiliary dielectric layers provided in the first region and each of the plurality of main dielectric layers include different main components of a dielectric ceramic.

2. The multilayer ceramic capacitor according to claim 1, wherein
each of the plurality of interlayer regions includes a third region located between the first lateral surface and a corresponding one of the plurality of the internal electrodes;
each of the plurality of auxiliary dielectric layers is provided in the third region; and
each of the plurality of auxiliary dielectric layers provided in the third region and each of the plurality of auxiliary dielectric layers provided in the first region include a same main component of a dielectric ceramic.

3. The multilayer ceramic capacitor according to claim 1, wherein a dimension of one of the plurality of auxiliary dielectric layers provided in the second region in the lamination direction is about 0.1 μm or more and about 5.0 μm or less.

4. The multilayer ceramic capacitor according to claim 1, wherein
the plurality of internal electrodes includes a first internal electrode exposed at the first end surface and a second internal electrode exposed at the second end surface;
the first external electrode is connected to the first internal electrode; and
the second external electrode is connected to the second internal electrode.

5. The multilayer ceramic capacitor according to claim 1, wherein the plurality of internal electrodes includes first internal electrodes exposed at the first end surface and a first floating internal electrode located between the first internal electrode and the first internal electrode in the lamination direction.

6. The multilayer ceramic capacitor according to claim 5, wherein the plurality of internal electrodes further include second internal electrodes exposed at the second end surface and a second floating internal electrode located between the second internal electrode and the second internal electrode in the lamination direction.

7. The multilayer ceramic capacitor according to claim 5, wherein the plurality of internal electrodes further include second internal electrodes exposed at the second end surface and a third floating internal electrode located between the first internal electrode and the second internal electrode in the length direction.

8. The multilayer ceramic capacitor according to claim 6, wherein the plurality of internal electrodes further include a third floating internal electrode located between the first internal electrode and the second internal electrode in the length direction.

9. The multilayer ceramic capacitor according to claim 1 further comprising:
a third external electrode on the multilayer body; wherein the plurality of internal electrodes include a first internal electrode and a second internal electrode;
the first external electrode is connected to the first internal electrode;
the second external electrode is connected to the first internal electrode; and
the third external electrode is connected to the second internal electrode.

10. The multilayer ceramic capacitor according to claim 9 further comprising:
a fourth external electrode on the multilayer body; wherein
the fourth external electrode is connected to the second internal electrode.

11. The multilayer ceramic capacitor according to claim 1, wherein the plurality of internal electrodes include a first internal electrode exposed at the first lateral surface and a second internal electrode exposed at the first lateral surface;
the first external electrode is connected to the first internal electrode; and
the second external electrode is connected to the second internal electrode.

12. The multilayer ceramic capacitor according to claim 1, wherein
the main component of each of the plurality of main dielectric layers is BaTiO₃; and
the main component of each of the plurality of auxiliary dielectric layers is CaTiO₃.

13. The multilayer ceramic capacitor according to claim 1, wherein
the main component of each of the plurality of main dielectric layers is BaTiO₃; and
the main component of each of the plurality of auxiliary dielectric layers is CaZrO_{3.}

14. The multilayer ceramic capacitor according to claim 4, wherein
each of the plurality of interlayer regions includes a third region located between the first lateral surface and a corresponding one of the plurality of the internal electrodes;
each of the plurality of auxiliary dielectric layers is provided in the third region; and
each of the plurality of auxiliary dielectric layers provided in the third region and each of the plurality of auxiliary dielectric layers provided in the first region include a same main component of a dielectric ceramic.

15. The multilayer ceramic capacitor according to claim 5, wherein
each of the plurality of interlayer regions includes a third region located between the first lateral surface and a corresponding one of the plurality of the internal electrodes;
each of the plurality of auxiliary dielectric layers is provided in the third region; and
each of the plurality of auxiliary dielectric layers provided in the third region and each of the plurality of auxiliary dielectric layers provided in the first region include a same main component of a dielectric ceramic.

16. The multilayer ceramic capacitor according to claim 9, wherein
each of the plurality of interlayer regions includes a third region located between the first lateral surface and a corresponding one of the plurality of the internal electrodes;
each of the plurality of auxiliary dielectric layers is provided in the third region; and
each of the plurality of auxiliary dielectric layers provided in the third region and each of the plurality of auxiliary dielectric layers provided in the first region include a same main component of a dielectric ceramic.

17. The multilayer ceramic capacitor according to claim 11, wherein
each of the plurality of interlayer regions includes a third region located between the first lateral surface and a corresponding one of the plurality of the internal electrodes;
each of the plurality of auxiliary dielectric layers is provided in the third region; and
each of the plurality of auxiliary dielectric layers provided in the third region and each of the plurality of auxiliary dielectric layers provided in the first region include a same main component of a dielectric ceramic.

18. The multilayer ceramic capacitor according to claim 4, wherein
the main component of each of the plurality of main dielectric layers is BaTiO₃; and
the main component of each of the plurality of auxiliary dielectric layers is CaTiO₃.

19. The multilayer ceramic capacitor according to claim 9, wherein
the main component of each of the plurality of main dielectric layers is BaTiO₃; and
the main component of each of the plurality of auxiliary dielectric layers is CaTiO₃.

20. The multilayer ceramic capacitor according to claim 11, wherein
the main component of each of the plurality of main dielectric layers is BaTiO₃; and
the main component of each of the plurality of auxiliary dielectric layers is CaTiO₃.
